(19) United States
(12) Patent Application Publication
(10) Pub. No.: US 2021/0158496 A1
(43) Pub. Date: May 27, 2021

(54) HIGH RESOLUTION AND HIGH DEPTH OF FIELD CAMERA SYSTEMS AND METHODS USING FOCUS STACKING

(71) Applicant: INSTITUT NATIONAL D'OPTIQUE, Québec (CA)

(72) Inventors: Jean-Pierre BOUCHARD, Québec (CA); Francois BERTHIAUME, Québec (CA); Geoffroi COTE, Québec (CA); Nathalie BLANCHARD, Québec (CA)

(21) Appl. No.: 16/755,785

(22) PCT Filed: Oct. 19, 2018
(86) PCT No.: PCT/CA2018/051324

§ 371 Date: Apr. 13, 2020

Related U.S. Application Data
(60) Provisional application No. 62/575,058, filed on Oct. 20, 2017.
(60) Provisional application No. 62/698,360, filed on Jul. 16, 2018.

(51) Int. Cl. G06T 5/50; H04N 5/232

(52) U.S. Cl. CPC G06T 5/50; H04N 5/232133; G06T 2207/10016; G06T 2207/10148; G06T 2207/20221; H04N 5/23229

(57) ABSTRACT

A method and a system of imaging a scene are disclosed. The method can include acquiring, at a frame chip acquisition rate, a plurality of frame chip images of the scene while repeatedly scanning the scene across a range of focus positions. The method can also include generating, from the plurality of frame chip images, a sequence of fused frame images. A fused frame image is generated by a focus-stacking operation on a stack of N consecutive ones of the plurality of frame chip images, at least one of the N frame chip images used in generating one of the fused frame images also being used in generating at least another one of the fused frame images. The fused frame images can be displayed at a refresh rate greater than 1/N times the frame chip acquisition rate. A method of motion artifact reduction in focus-stacking imaging is also disclosed.

### TECHNICAL FIELD

The technical field generally relates to optical image acquisition and processing systems and methods, and more particularly, to camera systems and methods using focus stacking to capture images with enhanced depth of field and/or resolution for use in various fields including, but not limited to, medical and surgical applications.

### BACKGROUND

An operating or surgical video microscope is an optical instrument adapted for use by a surgeon or another healthcare professional to assist during surgical operations and other medical procedures. Medical fields in which operating microscopes are used include, without being limited to, neurosurgery, ophthalmic surgery, otorhinolaryngology surgery, plastic surgery, and dentistry. While state-of-the art operating video microscopes have certain ergonomic advantages over optical microscopes, they still have similar limitations in terms of the trade-off between optical resolution and depth of field. Challenges therefore remain in the field of video camera systems and methods suitable for use in surgical and other medical applications.

### SUMMARY

The present description generally relates to focus-stacking imaging techniques. More particularly, some aspects of the present techniques relate to camera systems and associated image processing methods configured for real-time acquisition, generation, processing and display of extended-depth-of-field video images for use in various applications that require or can benefit from enhanced images, particularly for real-time operation at video frame rates. For example, the present techniques can be applied to or implemented in various types of camera systems, including, without limitation, systems used in medical and surgical applications.

The techniques generally rely on focus stacking for acquiring images with high transverse resolution over an extended depth of focus. In focus stacking, multiple source images—referred to herein as “frame chip images” or simply “frame chips”—are acquired at different focus distances and combined into a composite image—referred to herein as a “fused frame image” or simply a “fused frame”—having a depth of field greater than that of any of the individual frame chips. Some implementations of the present techniques can overcome, circumvent or mitigate the trade-off between depth of field and transverse resolution achievable in conventional imaging systems.

In accordance with an aspect, there is provided a method of imaging a scene, including:
acquiring, at a frame chip acquisition rate, a plurality of frame chip images of the scene while repeatedly scanning the scene across a range of focus positions; and
generating, by a processor, a sequence of fused frame images from the plurality of acquired frame chip images, a given one of the fused frame images being generated by performing a focus-stacking operation on a stack of N consecutive ones of the plurality of frame chip images, N being an integer greater than one, at least one of the N frame chip images used in generating the given one of the fused frame images also being used in generating at least another one of the fused frame images.

In some implementations, the present method can include displaying the sequence of fused frame images as a fused video stream having a fused frame refresh rate greater than 1/N times the frame chip acquisition rate. In the present techniques, such a fused frame refresh rate can be achieved by sharing some frame chip images among fused frame images. In some implementations, N can range from two to ten, and the fused frame refresh rate can be equal to or greater than 15 frames per second (fps), or equivalently hertz (Hz), for example 30 fps. Also, depending on the application, at least one of the generating and displaying steps can be performed in real-time or near real-time, that is, concurrently with the acquiring step.

In some implementations, the step of repeatedly scanning the scene across the range of focus positions includes varying a focus of a focus-tunable device, which can include an electrically tunable lens.

Various image fusion techniques and approaches can be used to generate fused frame images with shared frame chip images according to the present techniques. For example, in some implementations, the fused frame images can be generated in a rolling or progressive fusion mode, while in other cases the fused frames can be generated in a pivoting fusion mode.

First, in rolling fusion, the method generates a new fused frame every time a new frame chip image is acquired by fusing this newly acquired frame chip image with the N−1 previously acquired frame chip image or images. This means, in particular, that the N−1 first acquired frame chip image or images of the stack of N Frame chip images used in generating a given fused frame image corresponds or correspond to the N−1 last acquired frame chip image or images of the stack of N frame chip images used in generating the fused frame image immediately preceding the given fused frame image.

In rolling fusion, the scene can be repeatedly scanned across the range of focus positions in a unidirectional scan pattern having a scan frequency f_{scan} that is N times less than the frame chip acquisition rate f_{FC}. For example, the unidirectional scan pattern can have a sawtooth waveform. The N Frame chip images of each stack can thus be acquired during a respective scan period of the unidirectional scan pattern, in the same acquisition order for every stack. In rolling fusion, a new fused frame image can be not only generated, but also displayed every time a new frame chip image is acquired. This allows the fused frame refresh rate f_{RR} to be equal to the frame chip acquisition rate. The fused frame refresh rate can therefore be N times higher in a rolling fusion mode that in a sequential fusion mode in which a new fused frame image is generated and displayed only once N new frame chip images have been acquired. The rolling fusion mode can be advantageous in producing a smoother video display without requiring the frame chip acquisition rate to be prohibitively high. However, it is noted that in some implementations described herein, a sequential fusion mode can alternatively be used to generate and optionally display the fused frame images.

Second, in pivoting fusion, a first and a last acquired frame chip image of the stack of N frame chip images used in generating a given fused frame image define a first pivot frame chip image and a second pivot frame chip image, respectively. The first pivot frame chip image corresponds to a last acquired frame chip image of the stack of N frame chip images used in generating the fused frame image immediately preceding the given one of the fused frame images. The second pivot frame chip image corresponds to a first acquired frame chip image of the stack of N frame chip images used in generating the fused frame image immediately following the given one of the fused frame images. That is, the last acquired frame chip image of a given fused frame image is used as the first frame chip of the next frame. Each fused frame image is therefore generated from a stack of N frame chip images including a first and a second pivot frame chip image shared with the previously and the next acquired stack, respectively. In some implementations, one of the first and second pivot frame chip images encompasses a shallowest focus position among the stack of N frame chip images and the other one of the first and second pivot frame chip images encompasses a deepest focus position among the stack of N frame chip images.

In pivoting fusion, the scene can be repeatedly scanned across the range of focus positions in a bidirectional scan pattern f_{scan} having a scan frequency that is 2(N−1) times less than the frame chip acquisition rate f_{FC}. Thus, the frame chip images can be acquired according to a bidirectional frame chip acquisition sequence of the form { . . . 2, 1, 2, . . . , N−1, N, N−1, . . . , 2, 1, 2, . . . }, where frame chip images used in generating consecutive fused frame images are acquired in reverse order, alternating between from 1 to N and from N to 1. In some implementations, the bidirectional scan pattern can have a triangular or a sinusoidal waveform. Furthermore, in pivoting fusion, a fused frame image can be generated and displayed every time a pivot frame chip image is acquired and fused with the (N−1) previously acquired frame chip images. As such, the fused frame refresh rate f_{RR} is equal to 1/(N−1) times the frame chip acquisition rate f_{FC}. The pivoting fusion refresh rate is therefore greater than the sequential fusion refresh rate, which is equal to f_{FC}/N, but less than (for N>2) or equal to (for N=2) the rolling fusion refresh rate, which is equal to f_{FC}.

In some implementations, performing the focus-stacking operation to generate a given one of the fused frame images can include fusing the N corresponding frame chip images concurrently (e.g., in a single operation), without generating any intermediate fused frame image. In other implementations, performing the focus-stacking operation to generate a given one of the fused frame images can include fusing the N corresponding frame chip images progressively, such that between 1 and N−1 intermediate fused frame images are generated in the process. In one embodiment, progressively fusing the N frame chip images includes iteratively fusing the N frame chip images together to generate, in N−1 iterations, the given one of the fused frame images, and, optionally, removing the n^{th} acquired frame chip image from memory by the end of the n^{th} iteration, n ranging from 1 to N−1. Removing the n^{th} acquired frame chip image from memory by the end of the n^{th} iteration can provide an efficient buffer management scheme since only the last acquired frame chip image, rather than up to N frame chip images, is stored in memory at each iteration, in addition to the current fused frame image. In some embodiments, the rolling fusion mode is implemented in a single-step, concurrent focus-stacking operation, and the pivoting fusion mode is implemented in a (N−1)-step, progressive focus-stacking operation.

Image fusion techniques based on multiscale decomposition can be used, for example a Laplacian pyramid decomposition approach. In such techniques, fusion is performed at the decomposition levels to generate a set of fused decomposition coefficient images, and reconstruction algorithms are used to form the fused image from the fused decomposition coefficient images.

In some implementations, the focus-stacking operation can include a multiscale decomposition and reconstruction operation. The multiscale operation can include, for a given one of the fused frame images to be generated, a step of decomposing the corresponding stack of N frame chip images to generate N multilevel structures each having P decomposition levels, P being an integer greater than one, for example ranging from 5 to 15, and more particularly from 3 to 7. The multilevel structures may be created using a pyramid transform, for example a Laplacian pyramid transform. Each decomposition level of each one of the N multilevel structures has an associated decomposition coefficient image organized as an array of pixel values and representing the corresponding frame chip image at decreasing resolutions, from a highest resolution at the first decomposition level to a lowest resolution at the P^{th} decomposition level. Image fusion can be carried out based on the decomposition coefficient images, as described below.

The multiscale operation can also include a step of creating, for each decomposition level, a fused decomposition coefficient image based on the N decomposition coefficient images associated with the corresponding decomposition level to obtain each one of a set of P fused decomposition coefficient images. In some implementations, creating the fused decomposition coefficient image can include, for each decomposition level, steps of receiving the N decomposition coefficient images associated with the corresponding decomposition level as N arrays of pixel values; determining an array of fused pixel values by applying, on a per pixel or per pixel group basis, a statistical operator on the N arrays of pixel values; and using the array of fused pixel values as the fused decomposition coefficient image. In some implementations, the statistical operator is a maximum operator. The application of the maximum operator can involve taking, on a pixel-by-pixel basis, the maximum among the absolute pixel values of the N decomposition coefficient images associated with each one of the P decomposition levels. However, in other implementations, other statistical measures or parameters can be used to determine, for each decomposition level, a saliency score indicative of the probability that each one of the N associated decomposition coefficient images will belong to the most in-focus frame chip image among the N corresponding frame chip images, and then use the decomposition coefficient image with the highest saliency score as the fused decomposition coefficient image for each decomposition level. In some implementations, the values of the P fused decomposition coefficient images thus determined can be further refined using various algorithms and techniques.

The multiscale operation can further include a step of reconstructing the given one of the fused frame images based on the set of P fused decomposition coefficient images. For example, each fused frame image can be formed by reconstruction of the fused decomposition coefficient images using appropriate reconstruction algorithms, for example a Laplacian pyramid reconstruction approach. The sequence of reconstructed fused frame images can be displayed as a fused video stream.

In some implementations, the multiscale decomposition and reconstruction operation includes a motion artifact reduction operation to compensate or at least reduce motion artifacts in displayed fused frame images. More detail regarding possible implementations of the motion artifact reduction operation are provided below.

In some implementations, the step of acquiring the plurality of frame chip images can include acquiring a fraction of the frame chip images with a shorter frame chip acquisition time to enhance a dynamic range of the fused frame images.

In accordance with another aspect, there is provided a non-transitory computer readable storage medium having stored thereon computer executable instructions for use with a camera system in focus-stacking imaging, the computer executable instructions, when executed by a processor, cause the processor to perform the following steps:
controlling the camera system to repeatedly scan the scene across a range of focus positions and acquire, during the scan, a plurality of frame chip images of a scene at a frame chip acquisition rate;
receiving the plurality of frame chip images from the camera system; and
generating, from the plurality of acquired frame chip images, a sequence of fused frame images, a given one of the fused frame images being generated by performing a focus-stacking operation on a stack of N consecutive ones of the plurality of frame chip images, N being an integer greater than one, at least one of the N frame chip images used in generating a given one of the fused frame images also being used in generating at least another one of the fused frame images.

In some implementations, the computer executable instructions, when executed by the processor, further cause the processor to control the camera system to display the sequence of fused frame images at a fused frame refresh rate greater than 1/N times the frame chip acquisition rate.

In some implementations, the generating step performed by the processor can include one or more of the following above-described non-limiting features: rolling fusion mode; pivoting fusion mode; single-step focus-stacking operation; progressive focus-stacking operation with generation of one or more intermediate fused frame images, with or without efficient buffer management; image fusion based on multiscale decomposition and reconstruction operation; and motion artifact reduction operation.

In accordance with another aspect, there is provided a computer device for use with a camera system in focus-stacking imaging, the computer device including: a processor; and a non-transitory computer readable storage medium as described herein, the non-transitory computer readable storage medium being operatively coupled to the processor.

In accordance with another aspect, there is provided a camera system for imaging a scene or target region to be observed, for example a surgical scene. The camera system can include:
an image capture device configured to acquire, at a frame chip acquisition rate, a plurality of frame chip images of the scene;

a focus-tunable device optically coupled to the image capture device, the focus-tunable device having a variable focus; and
a control and processing unit operatively coupled to the image capture device and the focus-tunable device, the control and processing unit being configured to control the focus-tunable device to vary the focus thereof to repeatedly scan the scene across a range of focus positions and to control the image capture device to acquire, during the scan, the plurality of frame chip images of the scene, the control and processing unit further being configured to: receive the plurality of frame chip images of the scene acquired by the image capture device; and generate, from the plurality of acquired frame chip images, a sequence of fused frame images, each fused frame image being generated by performing a focus-stacking operation on a stack of N consecutive ones of the plurality of frame chip images, N being an integer greater than one, at least one of the N frame chip images used in generating a given one of the fused frame images also being used in generating at least another one of the fused frame images.

In some implementations, the camera system can also include a display configured to receive the sequence of fused frame images from the control and processing unit and to display the sequence of fused frame images at a fused frame refresh rate greater than 1/N times the frame chip acquisition rate. For example, the camera system can include a monitor to display the fused video stream to an operator (e.g., a surgeon or another medical professional). In some implementations, the camera system can further include a light source for illuminating the scene while the image capture device detects light emanating from the scene for generating images thereof.

The focus-tunable device can be, or be part of, an objective of the camera system configured to collect light emanating from the scene and direct it onto an image sensor of the image capture device for detection thereby. In such implementations, the focus-tunable device can be a focus-tunable lens assembly made up of at least one lens having a variable focus for acquiring a stack of frame chips by axially scanning the focal plane of the system at different depths of focus across the scene. The focus-tunable lens assembly can be actuated electrically, mechanically or otherwise. In some implementations, an electrically tunable lens can be used to capture a set of images at multiple focal distances and at video rates, without or with minimal moving parts. Depending on the application, different continuous or discontinuous waveforms can be used to drive the electrically tunable lens including, but not limited to, sawtooth, triangular and sinusoidal waveforms. In a sawtooth waveform, the focal plane is raster scanned unidirectionally, so that stacks of frame chip images are acquired in the same order for every fused frame image. By contrast, with triangular and sinusoidal waveforms, the focal plane is generally raster scanned bidirectionally, so that stacks of frame chip images in consecutive fused frame images are acquired in reverse order. Sawtooth waveforms generally have more high frequency content due to their sharp step discontinuities, and therefore may tend to exhibit more ripples in the lens response than triangular waveforms. However, because frame chip images are acquired in the same order in each fused frame image, the ripples in sawtooth waveforms will tend to remain substantially constant from one frame to the next. It is to be noted that other implementations can use other types of actuators (e.g., mechanical) without departing from the scope of the present description.

The control and processing unit is generally configured to control and communicate with various components of the camera system, including the image capture device and the focus-tunable device, and to process the acquired frame chip images using image fusion and other image processing techniques to generate a sequence of fused frame images to be displayed, for example as a fused video stream. In some implementations, the control and processing unit can control the focus-tunable device via a lens driver configured to supply the focus-tunable lens assembly with a drive signal to vary its focal length. In some implementations, the control and processing unit can be used to synchronize the drive signal supplied by the lens driver with the image acquisition process carried out by the image sensor of the image capture device. In some implementations, the control and processing unit includes at least one of a field-programmable gate array and a graphics processing unit.

In accordance with another aspect, there is provided a computer-implemented method of motion artifact reduction in focus-stacking imaging. The method can be used to compensate or at least reduce motion artifacts in video streams in which each displayed frame is a composite image resulting from the fusion of multiple frame chip images, such as described above. Non-limiting examples of motion artifacts include movement of objects in the field of view of the camera between consecutive frame chip images. When each displayed frame image is a combination or fusion of multiple frame chip images acquired at different focal distances, an object in the scene may appear several times in a displayed frame if the object moves significantly between frame chip images. In contrast, in a conventional camera operating at the same display or refresh rate, such a moving object would appear blurred in the displayed image, which can be a more natural way of displaying motion in a digital imaging system. In some implementations, a multiscale image fusion approach such as described above may be used to eliminate or at least mitigate such motion artefacts.

More particularly, the computer-implemented method can include steps of receiving, by a processor, a stack of N frame chip images of a scene acquired at N respective focus positions; and performing, by the processor, a focus-stacking operation on the stack of N Frame chip images to generate a fused frame image with reduced motion artifacts. The focus-stacking operation can include steps of:
decomposing the stack of N frame chip images to generate N multilevel structures each having P decomposition levels, P being an integer greater than one, each decomposition level of each one of the N multilevel structures having an associated decomposition coefficient image organized as an array of pixel values and representing the corresponding frame chip image at decreasing resolutions, from a highest resolution at the first decomposition level to a lowest resolution at the P^{th} decomposition level;
identifying one or more motion-detected regions in which corresponding pixel values in at least two of the N decomposition coefficient images of a reference decomposition level differ from one another by more than a motion-detection threshold according to a statistical dispersion parameter, the reference decomposition level being one of the P decomposition levels other than the first decomposition level;
creating, for each decomposition level, a fused decomposition coefficient image by applying, in accordance with the one or more motion-detected regions, a location-dependent statistical operator on the N decomposition coefficient images of the corresponding decomposition level to obtain each one of a set of P fused decomposition coefficient images; and
reconstructing the fused frame image with reduced motion artifacts based on the set of P fused decomposition coefficient images.

In some implementations, the computer-implemented method can further include a step of controlling a display to display the fused frame image with reduced motion artifacts as part of a fused video stream.

In some implementations, the focus-stacking operation can include a Laplacian pyramid decomposition stage and a Laplacian pyramid reconstruction stage.

In some implementations, the statistical dispersion parameter is a mean absolute deviation around a mean or a median of the corresponding pixel values in the at least two of the N decomposition coefficient images of the reference decomposition level. In some implementations, the at least two of the N decomposition coefficient images consist of all the N decomposition coefficient images.

In some implementations, the location-dependent statistical operator is applied on a pixel-by-pixel basis on the N decomposition coefficient images of each decomposition level. In such implementations, the location-dependent statistical operator can include a mean operator, a median operator, a maximum operator, or a combination thereof, in one or more locations of the N decomposition coefficient images that correspond to the one or more motion-detected regions, and a maximum operator in the remaining locations of the N decomposition coefficient images.

In some implementations, the computer-implemented method can involve comparing, on a pixel-by-pixel basis, the pixel intensities between frame chip images at a certain lower decomposition level (i.e., the reference decomposition level). If the mean absolute deviation between the N pixel intensities is found to differ by more than a predetermined threshold, then the fused pixel value to be used for each such pixel can be obtained by taking, for every level of the decomposition, the arithmetic mean or the median, rather than the maximum, of the decomposition coefficient images of all the frame chips. In some implementations, depending on how much pixel intensity values deviate from one another according to a certain statistical measure, the fused decomposition coefficient image to be displayed can be a weighted average of a fully blurred image and a most salient image. This weighted average can be applied locally, on a pixel-by-pixel basis, upon detection of motion in the observed scene.

In accordance with another aspect, there is provided a non-transitory computer readable storage medium having stored thereon computer executable instructions that, when executed by a processor, cause the processor to perform the computer-implemented method of motion artifact reduction in focus-stacking imaging as described herein.

In accordance with another aspect, there is provided a computer device for use with a camera system in focus-stacking imaging, the computer device including a processor; a non-transitory computer readable storage medium as described herein, the non-transitory computer readable storage medium being operatively coupled to the processor.

In accordance with another aspect, there is provided a camera system for imaging a scene, including: an image capture device configured to acquire a stack of N frame chip images of a scene at N respective focus positions; a focus-tunable device optically coupled to the image capture device, the focus-tunable device having a variable focus; and a control and processing unit operatively coupled to the image capture device and the focus-tunable device, the control and processing unit being configured to control the focus-tunable device to vary the focus thereof successively through the N focus positions, the control and processing unit further being configured to perform a focus-stacking operation on the stack of N frame chip images to generate a fused frame image with reduced motion artifacts. The focus-stacking operation can include, inter alia, the decomposing, identifying, creating and reconstructing steps of the computer-implemented method of motion artifact reduction as described herein.

In accordance with an aspect, there is provided a method of imaging a scene, including: acquiring, at a frame chip acquisition rate, a plurality of frame chip images of the scene while repeatedly scanning the scene across a range of focus positions using a scan pattern having a sinusoidal waveform; generating, by a processor, a sequence of fused frame images from the plurality of acquired frame chip images, each fused frame image being generated by performing a focus-stacking operation on a stack of N consecutive ones of the plurality of frame chip images, N being an integer greater than one; and, optionally, displaying the sequence of fused frame images at a fused frame refresh rate.

In some implementations, the scan pattern has a scan frequency that is N times less than the frame chip acquisition rate. In some implementations, N is equal to three. In such a case, the stack of three frame chip images used in generating a given one of the fused frame images can consist of a first acquired frame chip image encompassing one of a shallowest focus position and a deepest focus position among the range of focus positions, a second acquired frame chip image centered on a centermost focus position among the range of focus positions, and a third acquired frame chip image encompassing the other one of the shallowest focus position and the deepest focus position among the range of focus positions.

In some implementations, the scan pattern has a scan frequency that is 2N times less than the frame chip acquisition rate. In some implementations, N is equal to three. In such a case, the stack of three frame chip images used in generating a given one of the fused frame images can consist of a first acquired frame chip image, a second acquired frame chip image, and a third acquired frame chip image. The second acquired frame chip image can be centered on a centermost focus position among the range of focus positions. The stacks of three frame chip images used in generating consecutive ones in the sequence of fused frame images can be acquired by scanning the scene in opposite directions.

In some implementations, the scan pattern has a scan frequency that is 2(N−1) times less than the frame chip acquisition rate. In some implementations, N is equal to two or three. In such a case, a first and a last acquired frame chip image of the stack of N frame chip images used in generating a given one of the fused frame images respectively define a first pivot frame chip image and a second pivot frame chip image. One of the first and second pivot frame chip images can encompass a shallowest focus position among the stack of N frame chip images and the other one of the first and second pivot frame chip images can encompass a deepest focus position among the stack of N frame chip images. The first pivot frame chip image corresponds to a last acquired frame chip image of the stack of N frame chip images used in generating the fused frame image immediately preceding the given one of the fused frame images. The second pivot frame chip image corresponds to a first acquired frame chip image of the stack of N frame chip images used in generating the fused frame image immediately following the given one of the fused frame images.

In accordance with other aspects, there are provided a non-transitory computer readable storage medium having stored thereon computer executable instructions that, when executed by a processor, cause the processor to perform the method of focus-stacking imaging using a sinusoidal scan waveform as described herein; a computer device for use with a camera system, the computer device including a processor and the non-transitory computer readable storage medium; and a camera system configured to implement the method.

In accordance with another aspect, there is provided a computer-implemented method of imaging a scene, including: receiving a stack of N frame chip images of the scene acquired at N different focus positions, N being greater than two, and performing a focus-stacking operation on the stack of N frame chip images to generate a fused frame image. The focus-stacking operation can include iteratively fusing together the N frame chip images to generate, in N−1 iterations, the fused frame image, and removing the n^{th} acquired frame chip image from memory by the end of the n^{th} iteration, n ranging from 1 to N−1. The computer-implemented method can provide an efficient buffer management scheme since only the last acquired frame chip image, rather than up to N frame chip images, is stored in memory during any one of the N−1 iterations.

In accordance with other aspects, there are provided a non-transitory computer readable storage medium having stored thereon computer executable instructions that, when executed by a processor, cause the processor to perform the method of focus-stacking imaging with efficient buffer management; a computer device for use with a camera system, the computer device including a processor and the non-transitory computer readable storage medium; and a camera system configured to implement the method.

In some implementations, the present techniques can be used in stereo vision applications, by using two camera systems as described herein to acquire two sets of image data about a scene from two different viewpoints, and then displaying these two images on a suitable stereoscopic display system to provide depth perception to the user.

In some implementations, the present techniques can be used for dynamic range enhancement. Such enhancement can involve acquiring one or a few of the frame chip images of each frame over a shorter acquisition or exposure time than the other frame chip images. This or these frame chips having a shorter acquisition time can be used to restore image information otherwise lost in saturated zones of the captured images. Such information can then be used to reconstruct an image without or with reduced saturation.

It is to be noted that other method and process steps may be performed prior, during or after the above-described steps. The order of one or more of the steps may also differ, and some of the steps may be omitted, repeated and/or combined, depending on the application. It is also to be noted that some method and process steps can be performed using various image processing techniques, which can be implemented in hardware, software, firmware or any combination thereof.

Compared to existing operating video microscopes, some implementations of the present techniques can increase the depth of field by more than two to five times, for example three times, while preserving the transverse resolution and other system characteristics such as working distance and size.

Other features and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features can be combined with one another, unless stated otherwise.

### BRIEF DESCRIPTION OF THE DRAWINGS

FIG. 1 is a schematic representation of a camera system, in accordance with a possible embodiment. FIG. 1A is an example of a unidirectional scan pattern having a sawtooth waveform and representing a plot of the focus position of the camera system of FIG. 1 as a function of time over three full scan periods. A few of the N focus positions at which the N frame chip images of each focal stack used in generating fused frame images are depicted.

FIGS. 2A to 2D show curves of ideal (thick solid lines) and realistic (thin solid lines) trajectories followed by the focus position as a function of time for an electrically tunable lens driven by a sawtooth driving waveform (FIG. 2A), a triangular driving waveform (FIG. 2B), a sinusoidal driving waveform (FIG. 2C) and a staircase triangular driving waveform (FIG. 2D), in accordance with possible embodiments.

FIGS. 3A to 3D illustrate four possible examples of frame chip acquisition sequences in a method of focus-stacking imaging using a sinusoidal scan waveform, with two (FIG. 3A) or three (FIGS. 3B to 3D) frame chip images per fused frame image.

FIG. 4 is a flow diagram of a method of focus-stacking imaging using a sinusoidal scan waveform, in accordance with a possible embodiment.

FIGS. 5A and 5B illustrate the relationships between the pre-trig delay τₚₜ, the integration time τᵢₙₜ, and the mid-chip reference point for a bidirectional frame chip acquisition sequence with pivot frame chips, without (FIG. 5A) and with (FIG. 5B) downtime between consecutive frame chip acquisitions, in accordance with possible embodiments.

FIG. 6 is a flow diagram of a method of focus-stacking imaging in which frame chip images are shared among fused frame images, in accordance with a possible embodiment.

FIGS. 7A to 7C schematically illustrate three possible fused frame generation and display modes: a sequential fusion mode (FIG. 7A); a rolling or progressive fusion mode (FIG. 7B); and a pivoting fusion mode (FIG. 7C).

FIG. 8A is a schematic diagrammatic representation of a Laplacian pyramid decomposition technique for use in a focus-stacking operation, in accordance with a possible embodiment. FIG. 8B is a schematic diagrammatic representation of a Laplacian pyramid reconstruction technique for use in a focus-stacking operation, in accordance with a possible embodiment.

FIG. 9 is a flow diagram of a computer-implemented method of motion artifact reduction in focus-stacking imaging, in accordance with a possible embodiment.

FIG. 10 is a schematic representation of an example of a frame chip acquisition scheme suitable for high-dynamic-range focal-stacking applications.

### DETAILED DESCRIPTION

In the present description, similar features in the drawings have been given similar reference numerals. To avoid cluttering certain figures, some elements may not be indicated, if they were already identified in a preceding figure. It should also be understood that the elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. More particularly, it will be understood that such spatially relative terms are intended to encompass different orientations in the use or operation of the present embodiments, in addition to the orientations exemplified in the figures.

Unless stated otherwise, the terms “connected” and “coupled”, and derivatives and variants thereof, refer herein to any connection or coupling, either direct or indirect, between two or more elements. For example, the connection or coupling between the elements may be mechanical, optical, electrical, logical, or any combination thereof.

The terms “a”, “an” and “one” are defined herein to mean “at least one”, that is, these terms do not exclude a plural number of items, unless stated otherwise.

Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

The present description generally relates to focus-stacking imaging techniques. Examples of methods, systems, non-transitory computer readable storage media, and computer devices implementing the present techniques are described herein. In some implementations, the present description relates to camera systems and associated processing methods for use in high resolution and/or high depth of field imaging applications. Some of the techniques described herein provide video camera systems and methods suitable for real-time, or near real-time, acquisition, generation, processing and display of enhanced images.

The present techniques generally use focus stacking for the acquisition of high transverse resolution images over an extended depth of focus. In the present description, the term “focus stacking”, or “focal stacking”, refers to a digital image processing technique of producing a composite or fused image having an extended depth of field from a stack of sub-images acquired at different focus positions. Each sub-image in the stack generally has a shallower depth of field than that of the composite image. In the present description, and sub-images used in generating a composite image by focal stacking imaging can be referred to as “frame chip images” or simply “frame chips”, while the composite image itself can be referred to as a “fused frame image” or simply a “fused frame”.

According to various non-limiting aspects disclosed herein, there are provided focus-stacking imaging techniques in which frame chip images are shared among fused frame images to increase the ratio of the fused frame refresh rate to the frame chip acquisition rate; focus-stacking imaging techniques with motion artifact reduction capabilities; focus-stacking imaging techniques employing a sinusoidal scan waveform; and focus-stacking imaging techniques implementing an efficient buffer management scheme. Depending on the application, any or all of these specific focus-stacking imaging techniques can be combined with one another, unless stated otherwise.

The present techniques can be useful in various applications that require or can benefit from high quality images, particularly for real-time or near real-time operation at video frame rates. For example, the present techniques can be applied to or implemented in various types of camera systems, including, without limitation, systems used in medical and surgical applications, robotics, telepresence and machine vision.

In the present description, the terms “light” and “optical”, and variants and derivatives thereof, are intended to refer to radiation in any appropriate region of the electromagnetic spectrum. These terms are not limited to visible light but can also include invisible regions of the electromagnetic spectrum including, without limitation, the terahertz (THz), infrared (IR) and ultraviolet (UV) spectral bands. For example, in non-limiting embodiments, the present techniques can be implemented with light having a wavelength band lying somewhere in the range from about 400 to about 780 nanometers (nm). However, this range is provided for illustrative purposes only and the present techniques may operate outside this range.

In optical imaging, the term “depth of field”, or “depth of focus”, refers to the range of distances along an imaging axis over which an observable scene is imaged with a sufficient degree of sharpness or clarity onto an image plane to be considered more or less in focus for the intended application. In optical imaging, the depth of field is closely related to the numerical aperture of the imaging lens system, with the higher the numerical aperture, the smaller the depth of field. While low numerical aperture focusing can offer extended depth of field, it does so at the expense of lower transverse resolution, which is the capability of an imaging system to resolve closely placed objects of an observable scene in a plane perpendicular to the imaging axis. Therefore, a trade-off generally exists between the depth of field and the transverse resolution achievable in an imaging system. Some implementations of the present techniques can overcome, circumvent or mitigate this trade-off.

In the present description, the terms “live”, “real-time” and “near real-time” are used as practical terms that depend on the particularities of the specifics of each application. These terms of degree generally refer to the fact that some embodiments of the present techniques can allow image acquisition, generation, processing and/or display to be performed relatively seamlessly on the typical scale of human perception, that is, with negligible or acceptable time lag or delay. For example, some implementations of the present techniques can output and display video images in real-time at a frame rate of at least 15 fps, for example at least 30 fps, although other frame rate values can be used in other implementations.

### Camera System Implementations

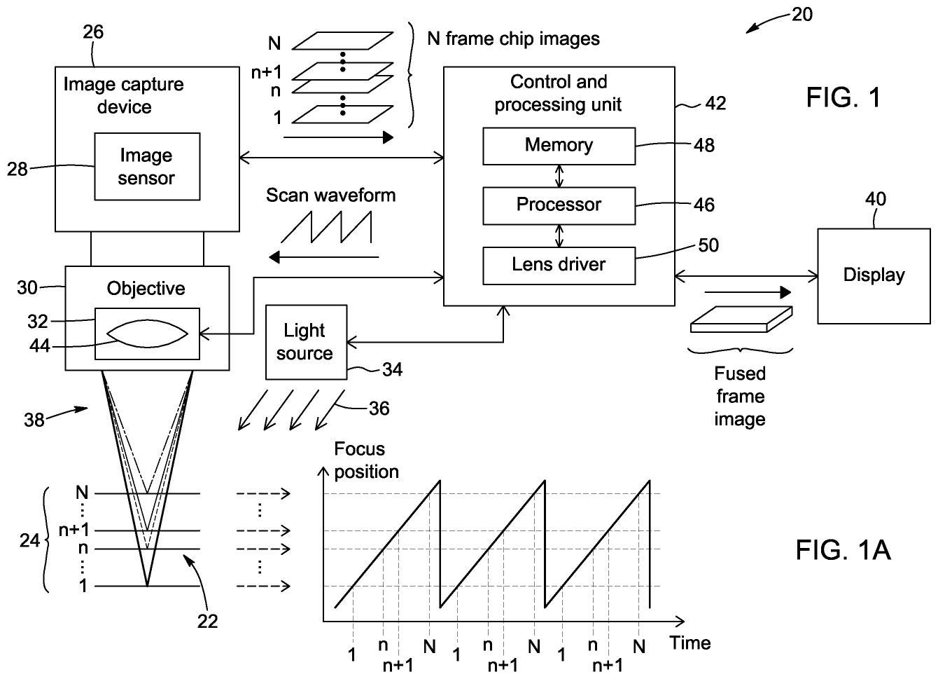

Referring to FIG. 1, there is illustrated a block diagram of a camera system 20 for imaging a scene 22, in accordance with a possible embodiment. In the present description, the term “scene” is meant to encompass any region, space, target, object, feature or information of interest which can be imaged by focal stacking according to the present techniques. The illustrated camera system 20 relies on real-time focal stacking with image fusion to acquire multiple images at different focus positions 24 using a lens assembly with electrically variable focal length, combine the multiple images captured at multiple focus distances into a single composite image having an enhanced depth of field, and display the extended-depth-of-field image at video rates. The camera system 20 of FIG. 1 may be used in medical or surgical procedures.

The camera system 20 generally includes an image capture device or camera 26 including an image sensor 28 and configured to acquire, at a frame chip acquisition rate, a plurality of frame chip images of the scene 22; an objective 30 including a focus-tunable device 32 optically coupled to the image capture device 26; a light source 34 for illuminating the scene 22 with illumination light 36 while the image capture device 26 detects light 38 emanating from the scene 22; a visual display 40 configured to display fused frame images; and a control and processing unit 42 operatively coupled to various components of the camera system 20. More detail regarding these and other possible components of the camera system 20 are provided below.

In the present description, the terms “image capture device” and “camera” refer broadly to any device or combination of devices capable of digitizing an image of a scene formed by a lens. Depending on the application, different types of cameras can be used including, without limitation, charge-coupled device (CCD) and complementary metal-oxide-semiconductor (CMOS) sensor-based cameras. The cameras can be high-resolution digital cameras, although lower resolution cameras can also be used. For example, the cameras can be high-speed video cameras capable of running at 60 fps or more.

The light source 34 is configured to generate illumination light 36 toward the scene 22, which in some implementations may be a surgical scene. The light source 34 can be embodied by any appropriate device or combination of devices apt to generate a light beam suitable for the intended imaging application. For example, in some surgical applications, the light source 34 can be a xenon light source or a light-emitting diode (LED) light source. Depending on the application, the illumination light 36 can be in the visible range or in any appropriate region of the electromagnetic spectrum.

Referring still to FIG. 1, light 38 emanating from the scene 22 is collected by the objective 30 and detected by the image sensor 28 of the image capture device 26. In the present description, the term “objective” generally refers to any lens or focusing optics, or assemblies thereof, used to form an image of a scene or target region under observation. The term is meant to encompass objectives made with refractive, reflective and/or diffractive components. In some implementations, the objective 30 can exhibit a central obscuration to position the illumination collinearly with the imaging optical axis.

The image sensor 28 is typically made up of a plurality of photosensitive elements (pixels) capable of detecting electromagnetic radiation incident thereonto from an observable scene and generating an image of the scene, typically by converting the detected radiation into electrical data. Depending on the application, the pixels may be arranged in a two-dimensional or a linear array. The image sensor 28 can be embodied by a CCD or a CMOS image sensor, although other types of sensor arrays, such as charge injection devices or photodiode arrays, could alternatively be used.

In illustrated embodiment of FIG. 1, the objective 28 includes a focus-tunable device 32 including a focus-tunable lens assembly. The focus-tunable lens assembly can include one or more lenses 44 or lens groups having a variable focus for the acquisition of the plurality of frame chip images at different focus positions 24. Alternatively, the focus-tunable device 30 can include one or more moving lenses or lens groups to achieve the focus variation.

Depending on the application, the focus-tunable lens assembly 30 can be actuated electrically, mechanically, or otherwise. In some implementations, the focus-tunable lens assembly 30 can include at least one electrically tunable lens. Using an electrically tunable lens can be advantageous for capturing a set of images at multiple focal distances and at video rates (e.g., at 30 fps or more), without or with minimal moving parts. Depending on the application, the electrically tunable lens can be controlled by current or voltage. In some implementations, the electrically tunable lens can be embodied by a liquid crystal lens, an electrowetting lens, a fluidic lens or an acousto-optic lens. In FIG. 1, the electrically tunable lens is driven with a sawtooth driving waveform, but other driving waveforms can be used in other embodiments, as discussed below. It is to be noted that while electrically tunable lenses can be advantageous in some applications, other embodiments can use mechanically tunable lenses without departing from the scope of the present description. It is also to be noted that in addition to the focus-tunable lens assembly 30, the objective 28 can include other optical components configured to collect, direct, collimate, focus, magnify or otherwise act on the light emanating from the target region 36.

Referring still to FIG. 1, the control and processing unit 42 refers to an entity of the camera system 20 that controls and executes, at least partially, the functions required to operate or communicate with the various components of the camera system 20 including, but not limited to, the image capture device 26 including the image sensor 28, the focus-tunable device 32, the light source 34, and the display 40. In some instances, the control and processing unit 42 can also be referred to as a “camera control unit” or a “computer device”. In the illustrated embodiment, the control and processing unit 42 generally includes a processor 46, one or more memory elements 48, and a lens driver 46.

More particularly, the control and processing unit 42 can be configured to control the focus-tunable device 32 to vary the focus thereof to repeatedly scan the scene 22 across a range of focus positions 24. For this purpose, the lens driver 46 is configured to supply the focus-tunable device 32 with a drive current or voltage to vary its focus length. Referring to FIG. 1A, there is provided an example of a unidirectional scan pattern having a sawtooth waveform and representing the focus position of the camera system of FIG. 1 plotted as a function of time over three full scan periods. A few of the N focus positions at which the N frame chip images of each focal stack used in generating fused frame images are depicted in FIG. 1A. Returning to FIG. 1, the control and processing unit 42 can also be configured to control the image capture device 26 to acquire, during the scan, the plurality of frame chip images of the scene 22. In some implementations, the control and processing unit 42 can be used to synchronize the drive signal supplied by the lens driver 38 with the image acquisition process carried out by the image sensor 26. The control and processing unit 42 can further be configured to receive the plurality of frame chip images of the scene 22 acquired by the image capture device 26, and to generate, from the plurality of acquired frame chip images, a sequence of fused frame images, each fused frame image being generated by performing a focus-stacking operation on a stack of N consecutive ones of the plurality of frame chip images. In some implementations, the number N of frame chip images used in generating each fused frame image can range between two and five, although using more than five frame chip images per fused frame image can be envisioned in other implementations. The focus-stacking operation can include appropriate image fusion algorithms and other image processing techniques to generate the sequence of fused frame images in a suitable format so as to be displayed as a fused video stream on the display 40. More detail regarding various possible implementations of the focus-stacking operation according to the present techniques will be provided below.

Depending on the application, the control and processing unit 42 can be provided within one or more general purpose computers and/or within any other suitable computing devices, implemented in hardware, software, firmware, or any combination thereof, and connected to various components of the camera system 20 via appropriate wired and/or wireless communication links and ports. Depending on the application, the control and processing unit 42 may be integrated, partially integrated, or physically separate from the optical hardware of the camera system 20, including, but not limited to, the image capture device 26, the objective 30 including the focus-tunable device 32, the light source 34, and the display 40.

The processor 46 may implement operating systems, and may be able to execute computer programs, also generally known as commands, instructions, functions, processes, software codes, executables, applications, and the like. It should be noted that although the processor 46 is shown in FIG. 1 as a single entity, this is for illustrative purposes only, and the term “processor” should not be construed as being limited to a single processor, and accordingly, any known processor architecture may be used. In some implementations, the processor 46 may include a plurality of processing units, for example a plurality of interconnected video processing units. Such processing units may be physically located within the same device, or the processor 46 may represent processing functionality of a plurality of devices operating in coordination. For example, the processor 46 may include or be part of one or more of a computer; a microprocessor; a microcontroller; a coprocessor; a central processing unit (CPU); an image signal processor (ISP); a digital signal processor (DSP) running on a system on a chip (SoC); a dedicated graphics processing unit (GPU); a special-purpose programmable logic device embodied in hardware device such as, for example, a field-programmable gate array (FPGA) or an application-specific integrated circuit (ASIC); a digital processor; an analog processor; a digital circuit designed to process information; an analog circuit designed to process information; a state machine; and/or other mechanisms configured to electronically process information and to operate collectively as a processor. More particularly, in some implementations, the processor 46 can be a fast, dedicated processor such as, for example, an FPGA or a GPU. Using a dedicated processor such as an FPGA or GPU may be useful in higher resolution or real-time video applications.

The control and processing unit 42 may include or be coupled to one or more memory elements 46 capable of storing computer programs and other data to be retrieved by the processor 44. The or each memory element 46 can also be referred to as a “computer readable storage medium”.

Referring still to FIG. 1, the visual display 40 may be provided as an integrated or standalone device or apparatus. For example, in one embodiment, the display 40 can be a high-definition medical grade LCD monitor. However, various other types of stationary or portable display devices can be used in other embodiments including, but not limited to, televisions, laptop and desktop computers, flat panel display devices, a projector projecting images on a display surface (e.g., a wall or screen), smartphones, tablet computers, personal digital assistants, and the like. Depending on the application, different types of display technology can be used including, but not limited to, liquid crystal display (LCD) technology, light-emitting diode (LED) technology, organic LED (OLED) technology, plasma display panel (PDP) technology, and active-matrix OLED (AMOLED) technology. In the present description, each image frame of the video stream displayed on the display 40 generally consists of a composite image created from the fusion of a stack of N sub-images acquired by repeatedly scanning the focal plane of the system 20 at N different depths of focus 24. In some non-limiting embodiments, the composite images can be displayed at a refresh rate greater than 15 fps, for example between about 30 fps to about 60 fps, and the sub-images can be captured at an acquisition rate of about 30 fps to about 500 fps. Depending on the application, the fused frame images can be displayed upon being generated, in real-time or near real-time, or be saved to memory for archival storage or later viewing and analysis.

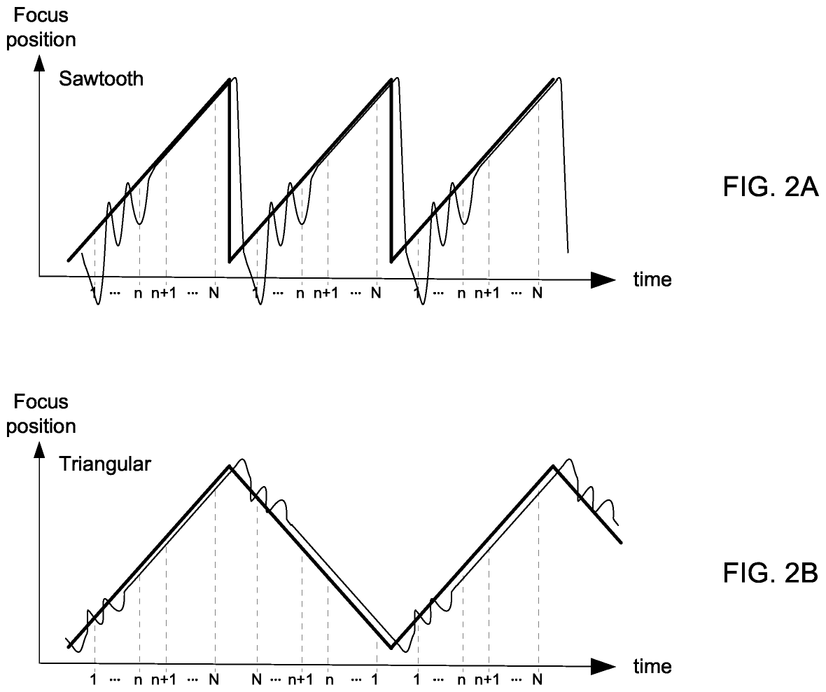

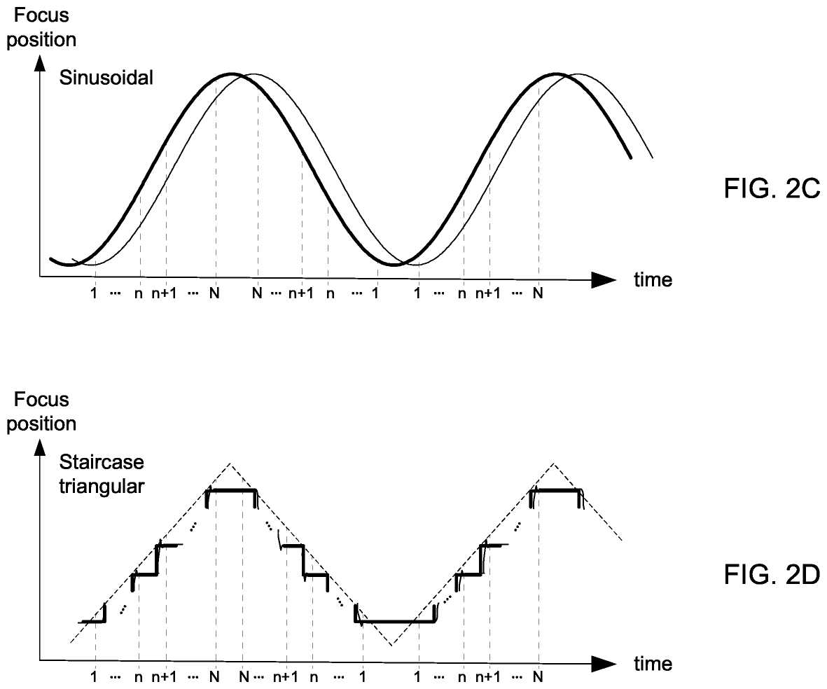

Referring now to FIGS. 2A to 2D, depending on the application, different scan patterns or waveforms can be used to drive an electrically tunable lens to scan a scene across a range of focus positions, such as in FIG. 1. Examples of standard scan waveforms include, without being limited to, sinusoidal, sawtooth, triangular and square waveforms, although other appropriate waveforms can be used including various non-sinusoidal, periodic or nearly periodic functions. FIGS. 2A to 2D show curves of ideal (thick solid lines) and realistic (thin solid lines) trajectories followed by the focus position as a function of time for an electrically tunable lens driven by a sawtooth driving waveform (FIG. 2A), a triangular driving waveform (FIG. 2B), a sinusoidal driving waveform (FIG. 2C) and a staircase triangular driving waveform (FIG. 2D), in accordance with possible embodiments. The scan waveform is continuous in FIGS. 2A to 2C and stepwise continuous, as in FIG. 2D.

In the present description, the terms “sinusoidal”, “triangular”, “sawtooth” and other like terms used to designate a waveform profile are meant to encompass not only pure sinusoidal, triangular and sawtooth waveforms, but also waveforms that are substantially or approximately sinusoidal, triangular and sawtooth, to a given tolerance, within the operational range of an exemplary embodiment. It will be understood that, in a given embodiment, the exact shape of the scan waveform generated by the lens driver can somewhat differ from that of an exact mathematical representation of a specified waveform yet be sufficiently close to it to be considered as such for practical purposes.

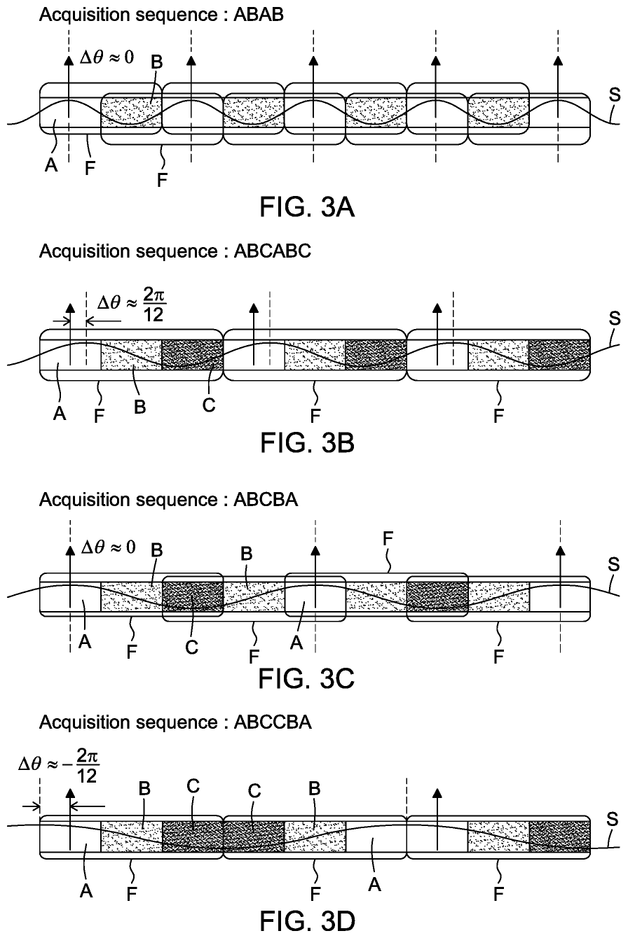

In a sawtooth scan waveform (FIG. 2A), the focal plane is raster scanned unidirectionally, so that every stack of N frame chip images is acquired in the same order (e.g., starting at frame chip 1 and ending at frame chip N for every frame). In a triangular or sinusoidal scan waveform (FIGS. 2B to 2D), the focal plane can be raster scanned bidirectionally, so that frame chip images in consecutive stacks are acquired in reverse order (e.g., starting at frame chip 1 and ending at frame chip N for one frame, but starting at frame chip N and ending at frame chip 1 for the next frame). It is noted that, in some implementations, it is possible to acquire every stack in the same order using triangular or sinusoidal waveforms (see, e.g., FIG. 3B). It is also noted that some implementations based on a triangular or sinusoidal scan waveform can use the following frame chip acquisition sequence: { . . . 2, 1, 2, . . . , N−1, N, N−1, . . . , 2, 1, 2, . . . }. In such a sequence, frame chip 1 is acquired only once, but used in two consecutive stacks, and likewise for frame chip N. Such a frame chip acquisition scheme can be used in pivoting fusion implementations, as described in greater detail below.

It is noted that for all the scan waveform profiles illustrated in FIGS. 2A to 2D, the realistic profile (thin solid lines) will generally differ at least slightly from the ideal profile (thick solid lines) due at least in part to the dynamic behavior of the focus-tunable lens. Ripples and delays on both focus positions and optical aberrations are therefore to be expected in actual implementations. A sawtooth waveform (FIG. 2A) has more high frequency content due to its sharp step discontinuities. This high frequency content of the sawtooth waveform will tend to excite higher-order response modes of the tunable lens, leading to more aberration in the lens transmitted wavefront. However, because frame chip images are acquired in the same order in every frame, the effect of ripples will tend to remain substantially constant from one frame to the next when employing a sawtooth waveform. As described further below, the use of a sawtooth scan waveform can also allow fused frame images to be displayed in a rolling, rather than sequential, fusion mode, as described in greater detail below. In contrast, a triangular waveform (FIG. 2B) generally presents less abrupt discontinuities at the frame edges and, for the same amplitude and frame rate, will usually generate less dynamic aberration. However, corresponding frame chip images in consecutive fused frame images are acquired with the lens being in slightly different states and moving in opposite directions. This can cause a flicker at half of the triangular wave frequency, although using a faster tunable lens and optimizing the driving waveform and frame chip trigger position can reduce this flicker to an acceptable or even negligible level. A limiting case of the optimized triangular-like waveform is the sinusoidal waveform (FIG. 2C). The sinusoidal waveform is composed of a single frequency component, and therefore will generally lead to less excitation of higher-order lens response modes for a given fundamental frequency. The sinusoidal waveform can therefore be a good choice for high frame rate applications when approaching the physical limits of the tunable lens response time.

FIGS. 2A to 2C depict examples of continuous scan waveforms, for which the lens is in motion during the integration time of the image sensor. In applications where the tunable lens stabilization time is sufficiently shorter than the desired frame chip acquisition time, a step-wise driving strategy may be employed as depicted in FIG. 2D. In this example, the lens driving waveform follows a staircase (or stepwise) triangular pattern, which leaves enough time at each step for the lens to stabilize prior to capturing each frame chip image.

Furthermore, in the examples of FIGS. 2A to 2D, the frame chip acquisition process is depicted as a series of instantaneous events. In practice, however, the integration time during which each frame chip image is acquired will be finite. In the limiting case of maximum or high light collection efficiency, the downtime between consecutive frame chip image acquisitions will be minimized or reduced, and the exposure of the next frame chip image will begin as soon as possible after the end of the exposure of the previous frame chip image. For continuous driving waveforms such as those depicted in FIGS. 2A to 2C, the focus of the tunable lens will therefore vary during the finite exposure time of each frame chip. The phase of the driving waveform with respect to the frame chip acquisition frequency can therefore be optimized or otherwise adjusted to achieve certain performance targets.

### Focus-Stacking Imaging With Sinusoidal Scan Waveform Implementations

FIGS. 3A to 3D illustrate examples of such scenarios for N=2 (FIG. 3A) and N=3 (FIGS. 3B to 3D), all using a sinusoidal lens driving waveform S. For simplicity, FIGS. 3A to 3D all assume a constant frame chip acquisition rate with a 100% duty cycle of the exposure (i.e., no downtime between consecutive frame chip acquisitions), but other duty cycle values and downtime conditions can be used in other implementations. In FIGS. 3A to 3D, the acquired frame chip images A, B and C are represented by rectangles and the generated and displayed fused frame images F are represented by rounded rectangles. In addition, upward pointing arrows are used to designate the mid-chip reference point of the first frame chip image of the corresponding frame chip acquisition sequence (i.e., the middle of frame chip image A) and dashed vertical lines are used to designate the maximum of the sinusoidal scan pattern S. The phase delay or shift, Δθ, between these two parameters is indicated in each case.

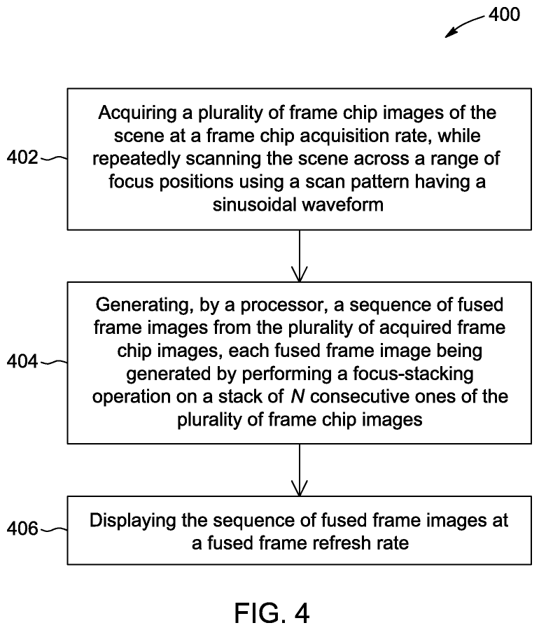

FIG. 4 provides a flow diagram of a possible embodiment of a method 400 of focus-stacking imaging using a sinusoidal scan waveform, which can be used to implement the image acquisition and fusion scenarios depicted in FIGS. 3A to 3D. The method 400 includes a step 402 of acquiring, with an image capture device, a plurality of frame chip images of the scene at a frame chip acquisition rate f_{FC}, while repeatedly scanning, with focus-tunable device, the scene across a range of focus positions with a scan pattern having a sinusoidal waveform. The method 400 also includes a step 404 of generating, by a processor, a sequence of fused frame images from the plurality of acquired frame chip images. Each fused frame image is generated by performing a focus-stacking operation on a stack of N consecutive ones of the plurality of frame chip images, for example N=2 in FIG. 3A and N=3 in FIGS. 3B to 3D. The method 400 includes an optional step 406 of displaying the sequence of fused frame images at a fused frame refresh rate f_{RR}.

In FIG. 3A, there are two frame chips per frame, labeled A and B. The sinusoidal lens driving waveform S has a scan frequency f_{scan} that is half the frame chip acquisition rate f_{FC} and the fused frame refresh or display rate f_{RR} is equal to the frame chip acquisition rate f_{FC}. In the illustrated embodiment, the middle of each frame chip image substantially coincides with a maximum (for frame chip images A) or a minimum (for frame chip images B) of the driving waveform. This scenario corresponds to an approximately zero-degree phase delay (Δθ=0) between the frame chip acquisition sequence and the sinusoidal scan pattern S. In some implementations, such an in-phase configuration can optimize or enhance the gain in depth of field while minimizing or reducing blur effects caused by the time-varying focal position of the lens. It is noted that an exact in-phase configuration may be challenging to achieve in practice, because real systems generally exhibit delays between the lens driving signal and the actual lens response. In some embodiments, the phase shift between the lens driving signal and the frame chip acquisition sequence can be adjustable at the system level, and therefore be optimized or otherwise varied while monitoring overall system performance. The example of FIG. 3A with N=2 can be interpreted as embodying either a rolling fusion mode, since a new fused frame image is generated every time a new frame chip image is acquired by fusing this newly acquired frame chip image with the previously acquired frame chip image, or a pivoting fusion mode, since the last acquired frame chip image of the stack used in generating a certain fused frame image is the same as the first acquired frame chip image of the stack used in generating the following fused frame image. These fusion modes are described in greater detail below.

When N=3, more frame chip acquisition scenarios are available, three possible examples of which are depicted in FIGS. 3B to 3D.

In FIG. 3B, the frame chip images are acquired according to a unidirectional frame chip acquisition sequence { . . . A, B, C, A, B, C, . . . }. The scan pattern S has a scan frequency f_{scan} is N=3 times less than the frame chip acquisition rate f_{FC}. Each stack of three frame chip images {A, B, C} used in generating a given fused frame image F can consist of a first acquired frame chip image (e.g., frame chip image A) encompassing one of a shallowest focus position and a deepest focus position among the range of focus positions, a second acquired frame chip image (e.g., frame chip image B) centered on a centermost focus position among the range of focus positions, and a third acquired frame chip image (e.g., frame chip image C) encompassing the other one of the shallowest focus position and the deepest focus position among the range of focus positions. The fused frame refresh rate f_{RR} is N=3 times less than the frame chip acquisition rate f_{FC}. In FIG. 3B, a phase delay Δθ of approximately 2π/12 is introduced between the frame chip acquisition sequence and the sinusoidal scan pattern S to evenly spread the mean focal position of each frame chip image. Such a phase delay in an N=3 operation mode can minimize or at least reduce the time between the acquisition of equivalent frame chips (e.g., between two consecutive frame chip images A). Such a configuration can, in turn, minimize or at least reduce potential motion artifacts that could occur when displaying a moving object. However, for a given fused frame refresh rate, the configuration of FIG. 3B is characterized by higher scan frequency compared to FIGS. 3C and 3D, implying a faster tunable lens. The lens also covers a relatively large range of focus positions during the acquisition of frame chip image B, which may increase focus-sweep-induced blur for this frame chip. In FIG. 3B, the fused frame images are generated and displayed in a sequential fusion mode (see below).

FIG. 3C illustrates a case of a bidirectional frame chip acquisition sequence of the form { . . . A, B, C, B, A, B, C, B, . . . }, in which the last frame chip of each frame, either frame chip A or C, is reused as the first frame chip of the following frame. In this implementation, the lens driving waveform S has a scan frequency f_{scan} that is 2(N−1)=4 times less than the frame chip acquisition rate f_{FC}. Each stack of three frame chip images {A, B, C} used in generating a given fused frame image F includes a first acquired frame chip image (frame chip image A or C) and a last acquired frame chip image (frame chip image C or A, respectively) that define a first and a second pivot frame chip image. One pivot frame chip image encompasses a shallowest focus position (frame chip image A) and the other encompasses a deepest focus position (frame chip image C). The first pivot frame chip image of a given fused frame image corresponds to the second pivot frame chip of the preceding fused frame image, and the second pivot frame chip image corresponds to the first pivot frame chip image of the following fused frame image. The fused frame refresh rate f_{RR} is equal to 1/(N−1)=½ times the frame chip acquisition rate f_{FC}. The reuse of frame chip images A and C in consecutive fused frame images provides a partial rolling fusion operation mode (referred to herein as a pivoting fusion mode), in which the fused frame refresh rate f_{RR} is only two times less than the frame chip acquisition rate f_{FC}, even though each displayed fused frame F image contains three frame chips. In FIG. 3C, there is no phase shift (i.e., Δθ=0) between the frame chip acquisition sequence and the sinusoidal scan pattern S. The range of focus positions covered during the acquisition of middle frame chip image B is less than in FIG. 3B.

FIG. 3D illustrates a case of a bidirectional frame chip acquisition sequence of the form { . . . A, B, C, C, B, A, . . . }, such that the stacks of three frame chip images used in generating consecutive ones in the sequence of fused frame images can be acquired by scanning the scene in opposite directions. In FIG. 3D, the last acquired frame chip image of each fused frame image—that is, either frame chip image A or C—is not reused as the first acquired frame chip image of the following fused frame image. Rather, the last acquired frame chip image of a given fused frame image and the first acquired frame chip image of the next fused frame image are acquired as two consecutive yet distinct acquisition events. Thus, the frame chip acquisition sequence includes single acquisitions of frame chip image B interspersed with alternating double acquisitions of frame chip image A and frame chip image C. In this implementation, the lens driving waveform S has a scan frequency f_{scan} that is 2N=6 times less than the frame chip acquisition rate f_{FC}, and the fused frame refresh rate f_{RR} is N=3 times less than the frame chip acquisition rate f_{FC}. In FIG. 3D, the stack of three frame chip images used in generating a given one of the fused frame images consists of a first acquired frame chip image (alternating between frame chip images A and C), a second acquired frame chip image (frame chip image B), and a third acquired frame chip image (alternating between frame chip images C and A, respectively). The second acquired frame chip image (frame chip image B) can be centered on a centermost focus position among the range of focus positions. In FIG. 3D, a phase delay Δθ of approximately −2π/12 is introduced between the frame chip acquisition sequence and the sinusoidal scan pattern S. The time interval between acquisitions of equivalent frame chips is the longest among the N=3 modes of FIGS. 3B to 3D, which may make this mode of operation more susceptible to motion artifacts. However, the range of focal positions covered during the acquisition of middle frame chip image B is the lowest among these N=3 modes, which can make frame chip image B in FIG. 3D less susceptible to focus-sweep-induced blur.

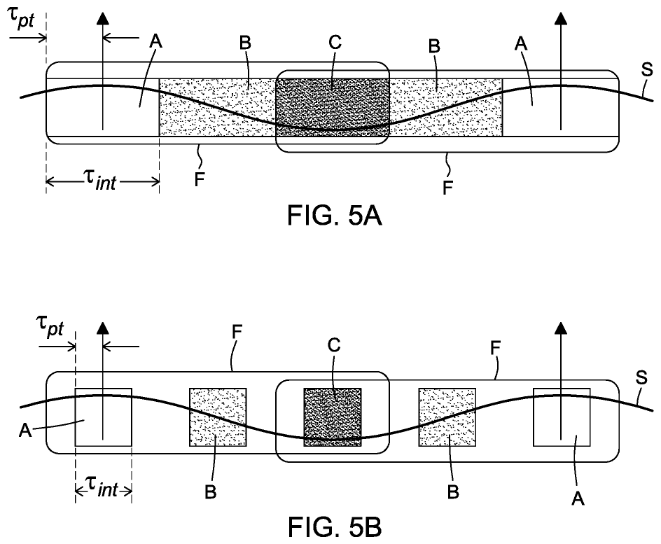

The examples of FIGS. 3A to 3D assumed, for simplicity, a maximum exposure time for a given frame chip acquisition rate, that is, a 100% duty cycle of the exposure. However, in some implementations, it may be desirable or required to decrease the integration time τᵢₙₜ, for example to prevent or help prevent saturation of the image sensor caused by excess light exposure. If the integration time τᵢₙₜ is decreased, the pre-trig delay τₚₜ between the onset of exposure and the mid-chip reference point may be adjusted so that the exposure period is still significantly centered on the mid-chip reference point. Such an adjustment can be performed to maintain a relatively constant span of mean focal distances across the N frame chips forming a displayed frame. FIGS. 5A and 5B illustrate examples of the relationship between the frame chip integration time τᵢₙₜ, the pre-trig delay τₚₜ and the mid-chip reference point (upward point arrows) for a frame chip acquisition sequence of the form { . . . A, B, C, B, A, B, C, . . . }, without (FIG. 5A) and with (FIG. 5B) downtime between consecutive frame chip acquisitions. In both cases, it is seen that τₚₜ is equal to τᵢₙₜ/2. However, in practice, the value used for τₚₜ may differ from τᵢₙₜ/2 to compensate or account for various sources of delay in the system.

Focus-Stacking Operation with Shared Frame Chip Images Implementations

In accordance with another aspect, there is provided a method of imaging a scene that includes a focus-stacking operation in which one or more frame chip images used to generate a given fused frame image is or are also used to generate another fused frame image. Such sharing of frame chip image among fused frame images can increase the ratio of the fused frame refresh rate to the frame chip acquisition rate.

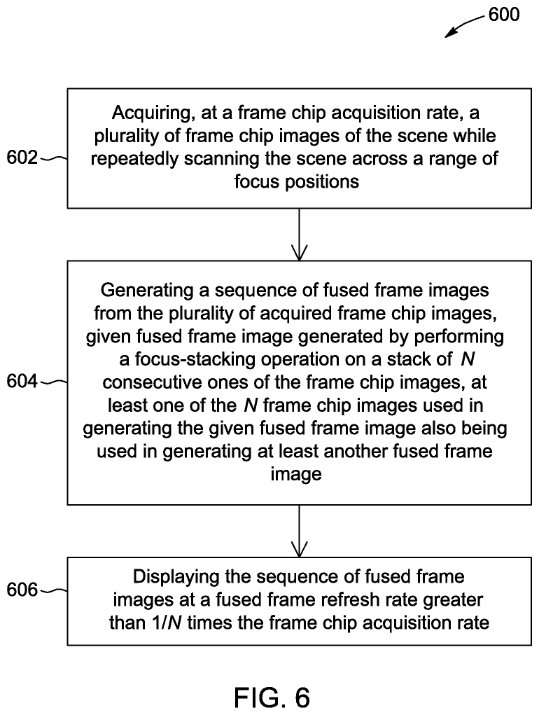

A possible embodiment of the method 600 is illustrated in the flow diagram of FIG. 6. The method 600 can include a step 602 of acquiring, with an image capture device, a plurality of frame chip images of the scene at a frame chip acquisition rate, while repeatedly scanning the scene across a range of focus positions. In some implementations, the frame chip acquisition rate can range between about 30 fps to about 500 fps, although values outside this range can be used in other implementations. In some implementations, scanning the scene across the range of focus positions can include changing over time a focus of a focus-tunable lens or device, whether electrically, mechanically or otherwise, as the frame chip images are sequentially acquired. Depending on the application, various scan waveforms can be used including, but not limited to, sawtooth, triangular and sinusoidal waveforms.

The method 600 can also include a step 604 of generating, by a processor, a sequence of fused frame images from the plurality of acquired frame chip images. A given one of the fused frame images can be generated by performing a focus-stacking operation on a stack of N consecutive ones of the plurality of frame chip images, N being an integer greater than one. In the method 600 of FIG. 6, at least one of the N frame chip images used in generating the given one of the fused frame images is also used in generating at least another one of the fused frame images. Thus, a number of frame chip images in each stack are shared among a number of fused frame images.

The method 600 can further include a step 606 of displaying the sequence of fused frame images, for example as a fused video stream, at a fused frame refresh rate greater than 1/N times the frame chip acquisition rate. Such a fused frame refresh rate can be achieved as a result of some frame chip images being shared among fused frame images. In some implementations, N can range from two to ten, and the fused frame refresh rate can be equal to or greater than 15 frames per second (fps) or hertz (Hz), for example between about 30 to about 60 fps.

Depending on the application, at least one of the generating and displaying steps can be performed in real-time or near real-time, that is, concurrently with the acquiring step. In the present description, the term “concurrently” refers to two or more processes that occur during coincident or overlapping time periods. In particular, the term “concurrently” does not necessarily imply complete synchronicity between the processes being considered. More particularly, in some implementations, the fused frame images can be displayed upon being generated, in real-time or near real-time, or be saved to memory for archival storage or later viewing and analysis. In yet other implementations, the generated fused frame images are only processed and analyzed, for example by the processor or another dedicated or generic system, without being displayed. Such automatic analysis could be carried out using artificial intelligence or other techniques and could be implemented in various applications including, but not limited to, fast inspection applications and automated monitoring applications. Any and all such combinations and variations are considered to be within the scope of embodiments of the present description.

Various image fusion schemes can be used to generate fused frame images with shared frame chip images according to the present techniques. For example, in some implementations, the fused frame images can be generated in a rolling fusion mode, while in other cases the fused frames can be generated in a pivoting fusion mode. The two fusion modes can differ by the rate at which fused frames can be generated and displayed and/or in whether stacks of frame chip images in consecutive frames are acquired in the same (unidirectional frame chip acquisition scheme) or in reverse (bidirectional frame chip acquisition scheme) order.

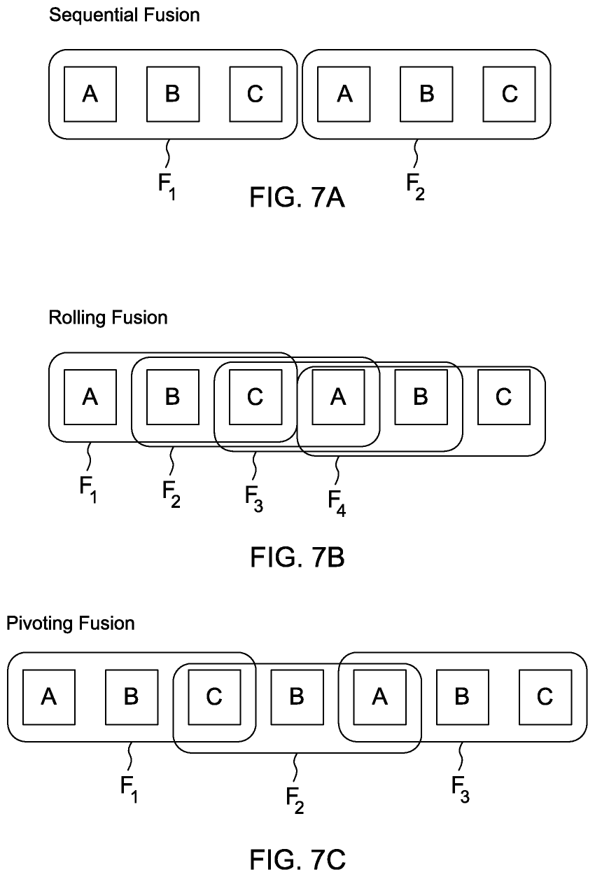

Referring now to FIGS. 7A to 7C, the rolling and pivoting fusion modes will be described in greater detail below and compared with a sequential fusion mode. It is noted that N=3 in FIGS. 7A to 7C, but other values could be used in other embodiments.

Referring to FIG. 7A, the sequential fusion mode is presented before discussing the rolling and pivoting fusion modes in FIGS. 7B and 7C, respectively. In sequential fusion implementations, the method waits until N frame chip images (A, B, C) have been acquired before reconstructing and displaying a next fused frame image (F₁, F₂). This means that if the frame chip acquisition rate is f_{FC}, then the fused frame refresh rate f_{RR} would be equal to f_{FC}/N. In the example of FIG. 7A, the method will involve acquiring three frame chip images (A, B, C) at three different focal depths; fusing those three frame chip images into a first fused frame image F₁; displaying the first fused frame image F₁; acquiring three new frame chip images A, B and C at the same three different focal depths; fusing those three new frame chip images into a second fused frame image F₂; displaying the second fused frame image F₂; and so on. It is to be noted that sequential fusion can generally be implemented for sawtooth, triangular, sinusoidal or any other appropriate scanning profiles. It is noted that some embodiments of the present techniques in which focus stacking is carried out without sharing of frame chip images among fused frame images may include a sequential fusion mode, such as illustrated in FIG. 7A, to generate and, optionally, display fused frame images from stacks of frame chip images.

Referring to FIG. 7B, in rolling fusion, the method generates a new fused frame (F₁, F₂, F₃, F₄) every time a new frame chip image (A; B; or C) is acquired by fusing this newly acquired frame chip image with the N−1 previously acquired frame chip images (B and C; C and A; or A and B;

respectively). This means, in particular, that the N−1 first acquired frame chip image or images of the stack of N frame chip images used in generating a given fused frame image corresponds or correspond to the N−1 last acquired frame chip image or images of the stack of N frame chip images used in generating the fused frame image immediately preceding the given fused frame image. In rolling fusion, the scene can be repeatedly scanned across the range of focus positions in a unidirectional scan pattern having a scan frequency f_{scan} that is N times less than the frame chip acquisition rate f_{FC}. In a unidirectional scan pattern, the scene is sequentially scanned only either from near to far focus distances or from far to near focus distances, but not both. Such a scan pattern can ensure that each one of the fused frame images is a composite image obtained from the fusion of N frame chip images acquired at a set of N different focus positions which is the same for all the fused frame images. In other words, the N frame chip images of each stack can be acquired during a respective scan period of the unidirectional scan pattern, in the same acquisition order for every stack. Non-limiting examples of possible unidirectional raster scanning patterns are a sawtooth scanning pattern (see, e.g., FIG. 2A) and a sinusoidal scanning pattern (see, e.g., FIG. 3B).

In rolling fusion, a new fused frame image can be not only generated, but also displayed every time a new frame chip image is acquired. This allows the fused frame refresh rate f_{RR} to be equal to the frame chip acquisition rate f_{FC}. A benefit of the rolling fusion mode is that the fused frame refresh rate f_{RR} can be N times higher than in the sequential fusion mode. High-quality video applications often involve a fused frame refresh rate of about 30 fps or more. This means that in sequential fusion implementations, providing a frame chip acquisition rate f_{FC} of at least N×30 Hz would be desirable, but could pose challenges due to data transfer rate and signal-to-noise ratio limitations. These challenges can be reduced or even avoided in rolling fusion mode implementations. Indeed, although operating at a frame chip acquisition rate f_{FC} significantly higher than 30 Hz may still be desirable or required to provide smooth video display, operating at less than N×30 Hz will generally be much less noticeable than in the sequential fusion mode. The rolling fusion mode can therefore provide increased flexibility in trading off between the number of frame chip images to be used in each fused frame image and the fused frame display rate.

Referring to FIG. 7C, in pivoting fusion, a first and a last acquired frame chip image (A and C) of the stack of N frame chip images (A, B, C) used in generating a given fused frame image (F₁, F₂, F₃) define a first pivot frame chip image and a second pivot frame chip image, respectively.

The first pivot frame chip image (e.g., C) and the second pivot frame chip image (e.g., A) associated with a given frame chip image (e.g., F₂) correspond to the last acquired frame chip image associated with the fused frame image (e.g., F₁) immediately preceding the given fused frame image and to the first acquired frame chip image associated with the fused frame image (e.g., F₃) immediately following the given fused frame image. In other words, referring more specifically to FIG. 7C, the last acquired frame chip image of a certain fused frame image, which from frame to frame alternates between frame chip image A and frame chip image C, is used as the first frame chip image of the next fused frame image. In some implementations, one pivot frame chip image is associated with a shallowest focus position among the N frame chip images of the stack and the other is associated with a deepest focus position among the N frame chip images of the stack.

In pivoting fusion, the scene can be repeatedly scanned across the range of focus positions in a bidirectional scan pattern f_{scan} having a scan frequency that is 2(N−1) times less than the frame chip acquisition rate f_{FC}. Thus, the frame chip images can be acquired according to a bidirectional frame chip acquisition sequence of the form { . . . 2, 1, 2, . . . , N−1, N, N−1, . . . , 2, 1, 2, . . . }, where frame chip images used in generating consecutive fused frame images are acquired in reverse order, alternating between from 1 to N and from N to 1. In such implementations, when the focal plane of the lens is brought at its nearest or farthest focus position, the corresponding frame chip (i.e., frame chip 1 or N, as the case may be) is acquired only once but used in generating two consecutive fused frame images.

Furthermore, a fused frame image can be generated and displayed every time a pivot frame chip image (A; or C) is acquired and fused with the (N−1) previously acquired frame chip images (C and B; or A and B; respectively), as depicted in FIG. 7C. Thus, each displayed fused frame image is generated from a stack of frame chip images that both begins and ends with a pivot frame chip image. As such, the fused frame refresh rate f_{RR} is equal to 1/(N−1) times the frame chip acquisition rate f_{FC}. The pivoting fusion refresh rate f_{RR} is therefore greater than the sequential fusion refresh rate, which is equal to f_{FC}/N, but less than (for N>2) or equal to (for N=2) the rolling fusion refresh rate, which is equal to f_{FC}. Depending on the application, the pivoting fusion mode can be acquired using, for example, a sinusoidal driving waveform, as in FIG. 3C. However, in other embodiments, a triangular driving waveform or other driving waveforms capable of implementing a bidirectional frame chip acquisition sequence could alternatively be used.

As for rolling fusion, pivoting fusion can allow a fused frame refresh rate f_{RR}=f_{FC}/(N−1), which is higher than the refresh rate f_{RR}=f_{FC}/N associated with sequential fusion. For example, in the case of N=3 depicted in FIG. 7C (see also FIG. 3C), a fused frame will be displayed every other frame chip image in pivoting fusion rather than every three frame chip images in sequential fusion (see, e.g., FIGS. 3B and 7A). In such a case, the display frame rate is one half of the frame chip acquisition rate f_{FC}. The pivoting fusion mode can provide similar benefit as rolling fusion in terms of reducing the requirement for high frame chip acquisition rates when a high display frame rate is desirable or required.

In some implementations, performing the focus-stacking operation to generate a given one of the fused frame images can include fusing the N corresponding frame chip images concurrently (e.g., in a single operation), without generating any intermediate fused frame image. Depending on the application, the sequential, rolling and pivoting fusion modes may all be implemented in a single-step, concurrent stacking operation.

In other implementations, performing the focus-stacking operation to generate a given one of the fused frame images can include fusing the N corresponding frame chip images progressively, such that between 1 and N−1 intermediate fused frame images are generated in the process. In one embodiment, progressively fusing the N Frame chip images includes iteratively fusing the N frame chip images together to generate, in N−1 iterations, the given one of the fused frame images, and, optionally, removing the n^{th} acquired frame chip image from memory by the end of the n^{th} iteration, n ranging from 1 to N−1. Removing the n^{th} acquired frame chip image from memory by the end of the n^{th} iteration can provide an efficient buffer management scheme since only the last acquired frame chip image, rather than up to N frame chip images, is stored in memory at each iteration. In some embodiments, either or both of the pivoting and sequential fusion modes can be implemented in a (N−1)-step, progressive focus-stacking operation, with or without efficient buffer management.

### Multiscale Decomposition and Reconstruction Implementations

Depending on the application, various image fusion algorithms can be used. In some implementations, the family of image fusion techniques based on multiscale decomposition and reconstruction can be well adapted for real-time focus-stacking imaging applications in video pipeline systems. Multiscale decomposition algorithms include pyramid transform and wavelet transform fusion, both of which can be used to implement the present techniques. Non-limiting examples of possible pyramid transform techniques include Laplacian and Gaussian pyramid decompositions. In such techniques, fusion is performed at the decomposition levels to generate a set of fused decomposition coefficient images, and reconstruction algorithms are used to form the fused image from the fused decomposition coefficient images. It is to be noted that the general principles underlying image fusion based on multiscale decomposition are known in the art and need not be covered in detail herein.

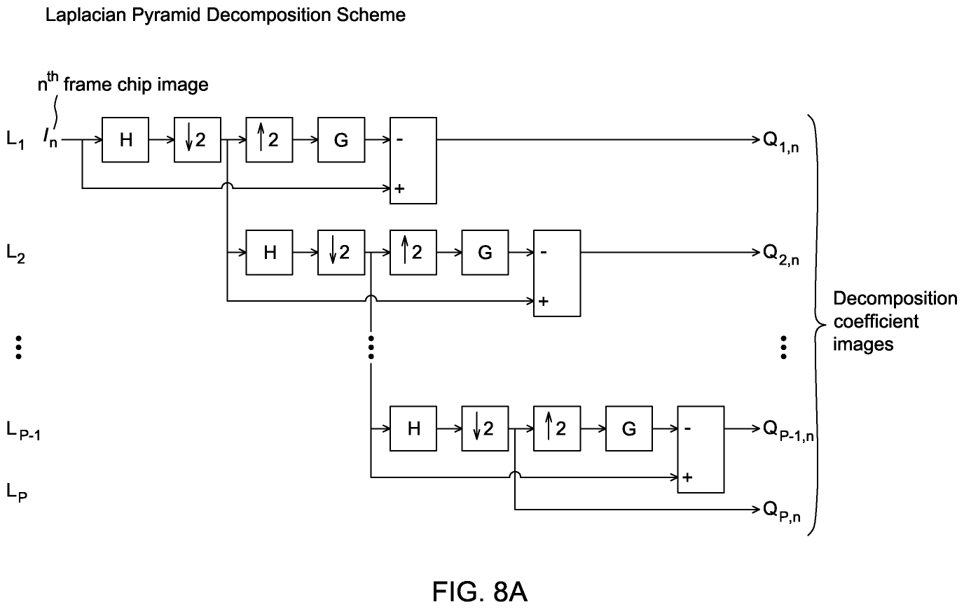

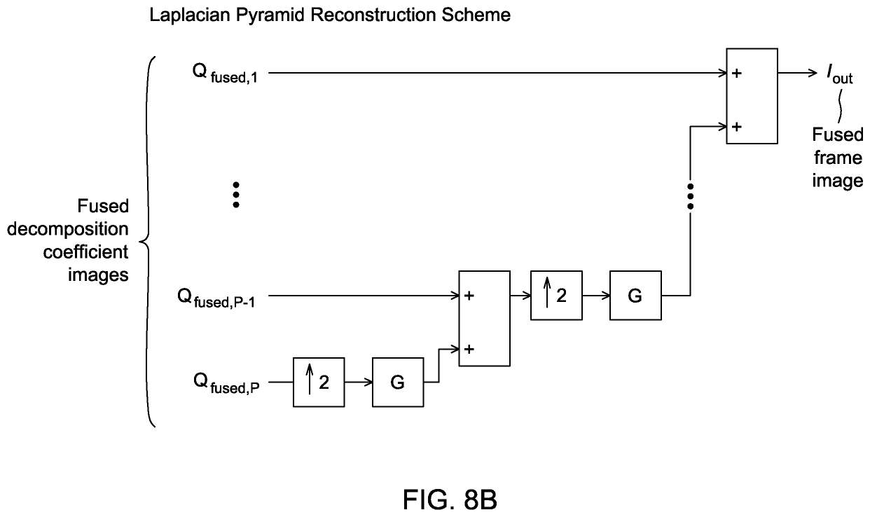

Referring to FIG. 8A, there is illustrated a schematic diagrammatic representation of a P-level Laplacian pyramid decomposition technique, which can be used to implement a focus-stacking operation in some implementations of the present techniques. The computation of the Laplacian pyramid can include, for a given fused frame image to be generated, a step of decomposing the corresponding stack of N frame chip images to generate N multilevel structures, or simply pyramids. Each pyramid has P decomposition levels, where P is an integer greater than one, for example ranging from 5 to 15, and more particularly from 3 to 7, although other values can be used depending on the application. The p^{th} decomposition level of the n^{th} pyramid has an associated decomposition coefficient image, Q_{p,n}, organized as an array of pixel values and representing the corresponding frame chip image at decreasing resolutions, from a highest resolution at the first decomposition level (p=1) to a lowest resolution at the last decomposition level (p=P).

More particularly, for the pyramid associated with a given chip image, Iₙ, the input image of level p is successively passed through a low-pass filter Hand down-sampled by a factor of two. The resulting down-sampled, low-pass filtered image is up-sampled by a factor of two, interpolated using kernel G, and subtracted from the input image of level p to produce the decomposition coefficient image Qₚ for level p. At the first level (p=1), the input image is the frame chip image itself, Iₙ. At intermediate levels (1<p<P), the input image is a copy of the down-sampled, low-pass filtered image obtained at the previous level (p−1). The process is repeated for each decomposition level p={1, 2, . . . , P−1}. Finally, at the last level (P=1), the decomposition coefficient image Q_{P} is obtained directly from the down-sampled, low-pass filtered image obtained at level P−1. The exemplary Laplacian pyramid depicted in FIG. 3 generates a set of P decomposition coefficient images Qₚ. Constructing the N pyramids associated with a stack of N frame chip images therefore involves computing N×P decomposition coefficient images Q_{p,n}. Image fusion can be carried out based on the decomposition coefficient images.

The multiscale decomposition operation can also include a step of creating, for the p^{th} decomposition level of the n^{th} pyramid, a fused decomposition coefficient image, Q_{fused,p}, based on the N decomposition coefficient images Q_{p,n} associated with the corresponding decomposition level to obtain each one of a set of P fused decomposition coefficient images. In some implementations, creating the fused decomposition coefficient image Q_{fused,p} for the p^{th} decomposition level can include steps of receiving the N decomposition coefficient images Q_{p,n}, n={1, 2, . . . , N} associated with the p^{th} decomposition level as N arrays of pixel values; determining an array of fused pixel values by applying, on a per pixel or per pixel group basis, a statistical operator on the N arrays of pixel values; and using the array of fused pixel values as the fused decomposition coefficient image. In some implementations, the statistical operator is a maximum operator. The application of the maximum operator can involve taking, on a pixel-by-pixel basis, the maximum among the absolute pixel values of the N decomposition coefficient images {Q_{p,1}, Q_{p,2}, . . . , Q_{p,N}} associated with the p^{th} decomposition levels, which may be expressed as follows:

Q_{fused,p,max}(a,b)=max[|Q_{p,1}(a,b)|,|Q_{p,2}(a,b)|, . . . ,|Q_{p,N}(a,b)|], for p={1,2, . . . , P}, (1)

where the pixel coordinate pair (a, b) indicates that this operation is carried out pixel-wise between the set of decomposition coefficient images {Q_{p,1}, Q_{p,2}, . . . , Q_{p,N}}.

However, in other implementations, other statistical measures or parameters can be used to determine, for each decomposition level, a saliency score indicative of the probability that each one of the N associated decomposition coefficient images of the p^{th} decomposition level will belong to the most in-focus frame chip image among the N corresponding frame chip images, and then use the decomposition coefficient image with the highest saliency score as the fused decomposition coefficient image for each decomposition level. Additionally, or alternatively, other algorithms and techniques can be used to compute the fused decomposition coefficient images Q_{fused,p}. of the p^{th} decomposition level. Depending on the application, the fused decomposition images Q_{fused,p} may or may not be determined using the same algorithm for all the P levels. In some implementations, the algorithm can involve a single step or operator, or multiple steps or operators. For example, in some embodiments, Q_{fused,p,max}, provided by Equation (1) can serve as a first approximation for Q_{fused,p}, which can subsequently be refined using further techniques. In addition, depending on the application, the fused decomposition images Q_{fused,p} may or may not be determined independently from one another. That is, in some embodiments, the calculation of the fused decomposition image Q_{fused,p} for level p can depend on the calculation of one or more other fused decomposition images Q_{fused,q}, where q≠p, for example |q−p|=1.

In some implementations, because the acquisition of the frame chip images of a given frame is performed in a sequential mode, so can be the computation of the decomposition coefficient images {Q_{p,1}, Q_{p,2}, . . . , Q_{p,N}} of a given level p. In such a case, the fused decomposition coefficient image Q_{fused,p,max} in Equation (1) can be obtained progressively by applying the maximum operator N−1 times, that is, by sequentially computing max[|Q_{p,1}|, |Q_{p,2}|], max[max[|Q_{p,1}|, |Q_{p,2}|], Q_{p,3}|], max[max[max[|Q_{p,1}|, |Q_{p,2}|], |Q_{p,3}|], |Q_{p,4}|], and so on until Q_{p,N} is obtained. Such an iterative computation scheme can improve buffer management efficiency since only one or a reduced number of values of Q_{p,n}, rather than up to N, values may be stored in memory for each level pat any iteration. Such efficient buffer management can be advantageous in applications where memory size and/or memory access bandwidth are limited. As mentioned above, efficient buffer management schemes can notably be implemented in sequential and pivoting fusion modes.

The multiscale operation can further include a step of reconstructing the given one of the fused frame images based on the set of P fused decomposition coefficient images. For example, each fused frame image can be formed by reconstruction of the fused decomposition coefficient images using appropriate reconstruction algorithms, for example a Laplacian pyramid reconstruction approach. The sequence of reconstructed fused frame images can be displayed as a fused video stream.

Referring to FIG. 8B, there is illustrated a schematic diagrammatic representation of a P-level Laplacian pyramid reconstruction technique, which is compatible with the decomposition technique of FIG. 8A. In this example, the fused frame image Iₒᵤₜ can be formed by reconstruction of the fused decomposition coefficient images Q_{fused,p}. Starting from the bottom of the reconstruction pyramid (i.e., level P), each fused decomposition coefficient image Q_{fused,p} is up-sampled by a factor of two and interpolated with kernel G. The resulting up-sampled, interpolated image is added to the fused decomposition coefficient image Q_{fused,p-1} of the next level until the top level (i.e., level 1) is reached and the fused frame image Iₒᵤₜ is generated and ready to be displayed. It is to be noted that the general principles underlying fused image reconstruction from processed multiscale decomposition images are known in the art and need not be covered in detail herein.

### Motion Artifact Reduction Implementations

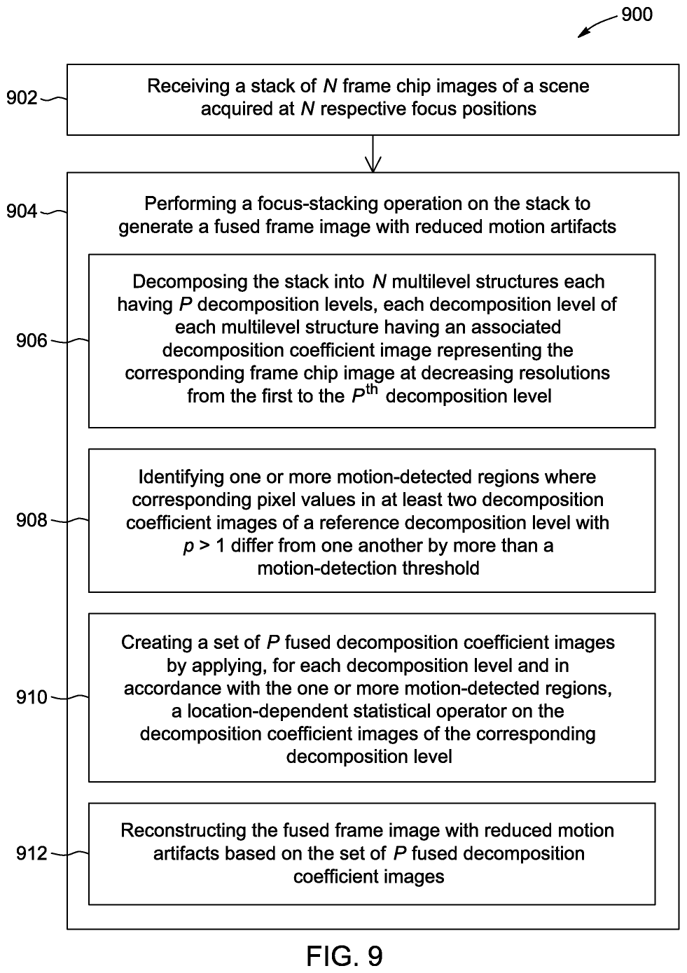

In accordance with another aspect, there is provided a computer-implemented method of motion artifact reduction in focus-stacking imaging. A possible embodiment of the method 900 is provided in FIG. 9. The method 900 can be used for correction or at least reduction of motion artifacts in a video stream in which each displayed frame is a composite image resulting from the fusion of multiple frame chip images sequentially captured at different focus positions, such as described above. Motion artifacts in captured frame chip images can be caused by different motion effects. One type of motion artifact can be caused by motion of the camera between consecutive frame chip images. Another type of motion artifact can be generated by movement of objects in the field of view of the camera between consecutive frame chip images. In medical applications, such as surgery, such motion artifacts can originate from surgical tool movement by the surgeon or from patient movement such as with breathing. When each displayed fused frame image is a combination of multiple frame chip images acquired at various focus distances, unnatural motion effects can become noticeable when objects are moving sufficiently fast between consecutive frame chip images. For example, the tip of a surgical instrument may appear multiple times in a displayed fused frame image if the instrument moves significantly between frame chip image acquisitions. In contrast, in a conventional camera operating at the same frame refresh rate, such a moving object would appear blurred in the displayed image, which is typically a more natural way of displaying motion in a digital imaging system.

The method 900 of FIG. 9 uses a multiscale image fusion approach such as described above to detect and remove or at least alleviate such motion artifacts. The method 900 uses the fact that going down the levels of the multiscale decomposition is similar to defocusing, so that lower levels (i.e., decomposition levels with larger p values) display less high spatial frequency components than higher levels (i.e., decomposition levels with smaller p values). This means that, in the absence of movement, decomposition coefficient images Q_{p,n} having larger p-index values, which represent the frame chip images at decreasing resolutions, are expected to be similar to one another, regardless of whether they are associated with in-focus or out-of-focus regions. Objects that are moving significantly between two consecutive frame chip acquisitions will, on the other hand, translate to pixel intensity variations in the region in motion even in those lower decomposition levels with larger p-index values.

Referring still to FIG. 9, the method 900 can include a step 902 of receiving, by a processor, a stack of N frame chip images of a scene acquired at N respective focus positions, and a step 904 of performing, by the processor, a focus-stacking operation on the stack of N frame chip images to generate a fused frame image with reduced motion artifacts. In some implementations, the focus-stacking operation comprises a Laplacian pyramid decomposition stage and a Laplacian pyramid reconstruction stage, although other multiscale image fusion techniques can be used in other implementations. In some implementations, N can range from 2 to 10, although values outside this range can be used in other implementations.

The focus-stacking operation can include a step 906 of decomposing the stack of N frame chip images to generate N multilevel structures each having P decomposition levels, P being an integer greater than one. The p^{th} decomposition level of the n^{th} multilevel structure has associated decomposition coefficient image Q_{p,n} organized as an array of pixel values and represents the corresponding frame chip image at decreasing resolutions, from a highest resolution at p=1 to a lowest resolution at p=P. In some implementations, P can range from 5 to 15, for example from 3 to 7, although values outside this range can be used in other implementations.

The focus-stacking operation can also include a step 908 of identifying one or more motion-detected regions in which corresponding pixel values in at least two of the N decomposition coefficient images of a reference decomposition level c differ from one another by more than a motion-detection threshold according to a statistical dispersion parameter. The reference decomposition level c is one of the P decomposition levels other than the first decomposition level (i.e., c≠1). For example, in some implementations, the reference decomposition level can be the third decomposition level (i.e., c=3). In some implementations, the statistical dispersion parameter is a mean absolute deviation around a mean, a median or another measure of central tendency of corresponding pixel values in the at least two decomposition coefficient images of the reference decomposition level c. It is noted that depending on the application, the identifying step 908 can be performed using either a single reference decomposition level or multiple reference decomposition levels, both scenarios being considered to be within the scope of the expression “a reference decomposition level”, unless stated otherwise.

The focus-stacking operation can further include a step 910 of creating, for each decomposition level, a fused decomposition coefficient image Q_{fused,p}. The fused decomposition coefficient image Q_{fused,p} can be created by applying a location-dependent statistical operator on the N decomposition coefficient images {Q_{p,1}, Q_{p,2}, . . . , Q_{p,N}} of the corresponding decomposition level to obtain each one of a set of P fused decomposition coefficient images {Q_{fused,1}, Q_{fused,2}, . . . Q_{fused,P}}. The nature of the location-dependent statistical operator varies in accordance with the one or more motion-detected regions. For example, in some implementations, the location-dependent statistical operator can be applied on a pixel-by-pixel basis on the N decomposition coefficient images {Q_{p,1}, Q_{p,2}, . . . , Q_{p,N}} of the p^{th} decomposition level. The location-dependent statistical operator can be a mean operator, a median operator, a maximum operator, or a combination thereof, in one or more locations of the N decomposition coefficient images {Q_{p,1}, Q_{p,2}, . . . , Q_{p,N}} corresponding to the one or more motion-detected regions, and a maximum operator in the remaining locations of the N decomposition coefficient images {Q_{p,1}, Q_{p,2}, . . . , Q_{p,N}}. Of course, the location-dependent statistical operator can have various forms depending on the application.

The focus-stacking operation can also include a step 912 of reconstructing the fused frame image with reduced motion artifacts based on the set of P fused decomposition coefficient images {Q_{fused,1}, Q_{fused,2}, . . . , Q_{fused,P}}.

According to some implementations of the method 900 of FIG. 9, comparing pixel intensity values between frame chip images at the reference decomposition level p=c can provide an effective way to detect object motion. For example, the intensity values of each pixel (a, b) of the decomposition coefficient images Q_{c,n} can be compared across the different frame chip images n={1, 2, . . . , N} of a given stack. This comparison can involve computing, pixel by pixel, the mean absolute deviation around the mean value or another statistical measure of dispersion of the N pixel values associated with the decomposition coefficient images Q_{c,1}, Q_{c,2}, . . . , Q_{c,N}. If this statistical measure of pixel value dispersion is above or below a certain motion-detection threshold, then this pixel is considered in motion. Repeating the process for each pixel of the c^{th} decomposition level can therefore create a binary motion mask. Alternatively, the statistical measure of dispersion can be mapped between two pre-determined values to generate a weighted motion mask. In the case of a decimated multi-level decomposition, each pixel of this motion mask corresponds to a pixel region in the original image. For non-decimated multi-level decomposition, a one-to-one relation exists between the motion map and the original image. The motion mask can then be used to select, for each pixel or pixel region, whether a most salient image Q_{fused,p,max} (see, e.g., Equation 1) or a blurred version thereof, Q_{fused,p,blur}, should be displayed. In the case of a weighted motion mask, a weighted average between a most salient image, Q_{fused,p,max}, and a blurred image, Q_{fused,p,blur}, can be displayed. Other means of combining the two images can also be used, depending on the application.

In some implementations, the blurred version Q_{fused,p,blur} of the image can be computed by taking, for every level p, the arithmetic mean or the median of the decomposition coefficient images of the N corresponding frame chip images. This can be expressed mathematically as follows when the arithmetic mean is used:

Q_{fused,p,blur}(a,b)=mean[Q_{p,1}(a,b),Q_{p,2}(a,b), . . . ,Q_{p,N}(a,b)], for p={1,2, . . . , P}, (2)

This approach to computing the fused decomposition coefficient images will tend to reduce the contrast of a moving object, which is similar to what would be obtained by combining the exposure times of the N frame chip images forming a displayed fused frame image. In some implementations, the resulting contrast-reduced fused decomposition coefficients can be further processed to achieve a desired level of smoothness and blurring of the motion artifacts. Such additional processing could include a convolution with an averaging kernel, such as a 3×3 boxcar filter or any other suitable filter kernel.

### High-Dynamic-Range Implementations

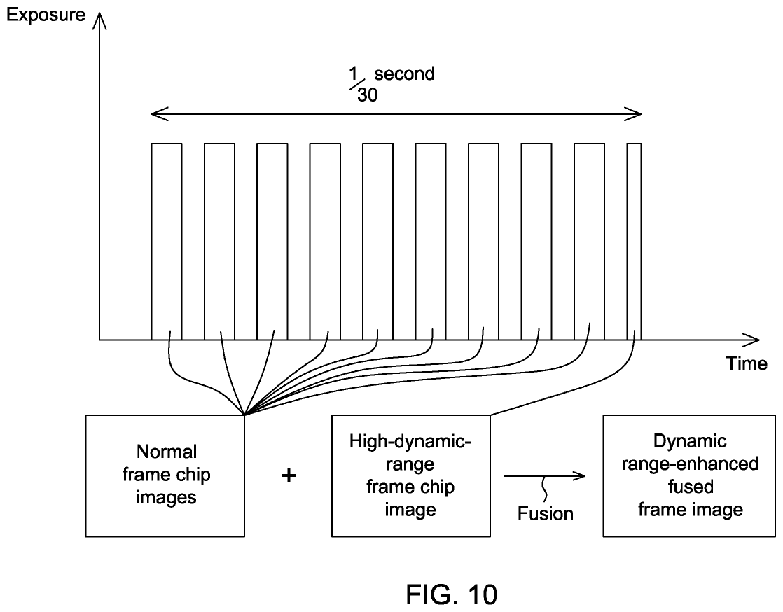

In some implementations, the present techniques can be used for dynamic range enhancement. Such enhancement can be achieved by acquiring one or a few of the N frame chips of each frame over acquisition times that are a fraction of the acquisition time of the remainder of the N frame chips. For example, this fraction can be of the order of ½ to 1/64 depending on the dynamic range of the scene. This is depicted in the non-limiting example provided in FIG. 10, where the acquisition time of the last, “high-dynamic-range” frame chip image of a stack used in generating a fused frame image is shorter than the acquisition time of the other N−1 “normal” frame chip images. In this example, the stack of N frame chip images is acquired over an acquisition time period of 1/30 second. The N^{th} frame chip image (high-dynamic-range frame chip image) with a shorter acquisition time can provide information about saturated zones in over-exposed areas of captured images. This information can then be used to reconstruct a dynamic-range-enhanced fused frame image without or with reduced saturation. It is noted that in other implementations, the high-dynamic-range frame chip image need not be the last acquired frame chip image of the stack and/or more than one high-dynamic-range frame chip image may be acquired per stack.

### Computer Readable Medium and Computer Device Implementations

In accordance with another aspect of the present description, there is provided a non-transitory computer readable storage medium having stored thereon computer readable instructions that, when executed by a processor, cause the processor to perform various steps of the methods disclosed herein, for example a focus-stacking operation. In the present description, the terms “computer readable storage medium” and “computer readable memory” are intended to refer to a non-transitory and tangible computer product that can store and communicate executable instructions for the implementation of various steps of the method disclosed herein. The computer readable memory can be any computer data storage device or assembly of such devices, including random-access memory (RAM), dynamic RAM, read-only memory (ROM), magnetic storage devices such as hard disk drives, solid state drives, floppy disks and magnetic tape, optical storage devices such as compact discs (CDs or CDROMs), digital video discs (DVD) and Blu-Ray™ discs; flash drive memory, and/or other non-transitory memory technologies. A plurality of such storage devices may be provided, as can be understood by those skilled in the art. The computer readable memory may be associated with, coupled to, or included in a computer or processor configured to execute instructions contained in a computer program stored in the computer readable memory and relating to various functions associated with the computer.

In some implementations, the computer executable instructions stored in the computer readable storage medium can instruct a processor to perform the following steps: controlling a camera system to repeatedly scan a scene across a range of focus positions and acquire, during the scan, a plurality of frame chip images of a scene at a frame chip acquisition rate; receiving the plurality of frame chip images from the camera system; and generating, from the plurality of acquired frame chip images, a sequence of fused frame images, a given one of the frame images being generated by performing a focus-stacking operation on a stack of N consecutive ones of the plurality of frame chip images, N being an integer greater than one, at least one of the N frame chip images used in generating the given one of the fused frame images also being used in generating at least another one of the fused frame images. In some implementations, the computer executable instructions stored in the computer readable storage medium can cause the processor to control the camera system to display the sequence of fused frame images at a fused frame refresh rate greater than 1/N times the frame chip acquisition rate. In some implementations, the computer executable instructions stored in the computer readable storage medium can cause the processor to perform various above-described aspects of a focus-stacking operation in which frame chip images are shared among fused frame images. In some implementations, the non-transitory computer readable storage medium having stored thereon computer executable instructions that, when executed by a processor, cause the processor to perform methods described above including, but not limited to, a method of focus-stacking imaging using a sinusoidal scan waveform, a method of focus-stacking imaging with efficient buffer management, and a method of focus-stacking imaging with motion artifact reduction capabilities.

In accordance with another aspect of the present description, there is provided a computer device including a processor and non-transitory computer readable storage medium having stored thereon computer readable instructions that, when executed by a processor, cause the processor to perform various steps of the methods disclosed herein, for example a focus-stacking operation. FIG. 1 depicts an example of a computer device 42 including a processor 46 and a non-transitory computer readable storage medium 48 operably connected to the processor 46. The non-transitory computer readable storage medium 48 has stored thereon computer readable instructions that, when executed by the processor 46, cause the processor 46 to perform various steps of focus-stacking imaging methods disclosed herein.

Of course, numerous modifications could be made to the embodiments described above without departing from the scope of the appended claims.

1-26. (canceled)

27. A computer-implemented method of motion artifact reduction in focus-stacking imaging, comprising:
receiving, by a processor, a stack of N frame chip images of a scene acquired at N respective focus positions; and
performing, by the processor, a focus-stacking operation on the stack of N frame chip images to generate a fused frame image with reduced motion artifacts, comprising:
decomposing the stack of N frame chip images to generate N multilevel structures each having P decomposition levels, P being an integer greater than one, each decomposition level of each one of the N multilevel structures having an associated decomposition coefficient image organized as an array of pixel values and representing the corresponding frame chip image at decreasing resolutions, from a highest resolution at the first decomposition level to a lowest resolution at the P^{th} decomposition level;
identifying one or more motion-detected regions in which corresponding pixel values in at least two of the N decomposition coefficient images of a reference decomposition level differ from one another by more than a motion-detection threshold according to a statistical dispersion parameter, the reference decomposition level being one of the P decomposition levels other than the first decomposition level;
creating, for each decomposition level, a fused decomposition coefficient image by applying, in accordance with the one or more motion-detected regions, a location-dependent statistical operator on the N decomposition coefficient images of the corresponding decomposition level to obtain each one of a set of P fused decomposition coefficient images; and
reconstructing the fused frame image with reduced motion artifacts based on the set of P fused decomposition coefficient images.

28. The computer-implemented method of claim 27, further comprising controlling a display to display the fused frame image with reduced motion artifacts as part of a fused video stream.

29. The computer-implemented method of claim 27, wherein the focus-stacking operation comprises a Laplacian pyramid decomposition stage and a Laplacian pyramid reconstruction stage.

30. The computer-implemented method of claim 27, wherein the statistical dispersion parameter is a mean absolute deviation around a mean or a median of the corresponding pixel values in the at least two of the N decomposition coefficient images of the reference decomposition level.

31. The computer-implemented method of claim 27, wherein, for each decomposition level, the location-dependent statistical operator is applied on a pixel-by-pixel basis on the N decomposition coefficient images of the corresponding decomposition level, the location-dependent statistical operator comprising a mean operator, a median operator, a maximum operator, or a combination thereof, in one or more locations of the N decomposition coefficient images corresponding to the one or more motion-detected regions, and a maximum operator in the remaining locations of the N decomposition coefficient images.

32. A non-transitory computer readable storage medium having stored thereon computer executable instructions that, when executed by a processor, cause the processor to perform the computer-implemented method of claim 27.

33. A computer device for use with a camera system in focus-stacking imaging, the computer device comprising:
a processor; and
the non-transitory computer readable storage medium of claim 32, the non-transitory computer readable storage medium being operatively coupled to the processor.

34. A camera system for imaging a scene, comprising:
an image capture device configured to acquire a stack of N frame chip images of a scene at N respective focus positions;
a focus-tunable device optically coupled to the image capture device, the focus-tunable device having a variable focus; and
a control and processing unit operatively coupled to the image capture device and the focus-tunable device, the control and processing unit being configured to control the focus-tunable device to vary the focus thereof successively through the N focus positions, the control and processing unit further being configured to perform a focus-stacking operation on the stack of N frame chip images to generate a fused frame image with reduced motion artifacts, the focus-stacking operation comprising:
decomposing the stack of N frame chip images to generate N multilevel structures each having P decomposition levels, P being an integer greater than one, each decomposition level of each one of the N multilevel structures having an associated decomposition coefficient image organized as an array of pixel values and representing the corresponding frame chip image at decreasing resolutions, from a highest resolution at the first decomposition level to a lowest resolution at the P^{th} decomposition level;
identifying one or more motion-detected regions in which corresponding pixel values in at least two of the N decomposition coefficient images of a reference decomposition level differ from one another by more than a motion-detection threshold according to a statistical dispersion parameter, the reference decomposition level being one of the P decomposition levels other than the first decomposition level;
creating, for each decomposition level, a fused decomposition coefficient image by applying, in accordance with the one or more motion-detected regions, a location-dependent statistical operator on the N decomposition coefficient images of the corresponding decomposition level to obtain each one of a set of P fused decomposition coefficient images; and
reconstructing the fused frame image with reduced motion artifacts based on the set of P fused decomposition coefficient images.
